(19) United States
(12) Patent Application Publication
(10) Pub. No.: US 2026/0261444 A1
(43) Pub. Date: Sep. 3, 2026

(54) BLOCKCHAIN-BASED BLOCK COMPRESSION METHOD AND APPARATUS, DEVICE, AND READABLE STORAGE MEDIUM

(71) Applicant: Tencent Technology (Shenzhen) Company Limited, Shenzhen (CN)

(72) Inventors: Guanghong LU, Shenzhen (CN); Hongbo ZHANG, Shenzhen (CN); Chunxiang WANG, Shenzhen (CN); Zhihong CAI, Shenzhen (CN)

(73) Assignee: Tencent Technology (Shenzhen) Company Limited, Shenzhen (CN)

(21) Appl. No.: 19/656,604

(22) Filed: Apr. 23, 2026

Related U.S. Application Data
(63) Continuation of application No. PCT/CN2025/097787, filed on May 28, 2025.

(30) Foreign Application Priority Data
Jul. 8, 2024 (CN) 202410910740.2

(51) Int. Cl. H04L 9/00; H03M 7/30

(52) U.S. Cl. CPC H04L 9/50; H03M 7/70

(57) ABSTRACT

Provided are a blockchain-based block compression method and apparatus, a device, and a readable storage medium. The method includes: obtaining M transaction data packets, a single transaction data packet including transaction attribute values of N transaction attribute types; determining position order of the M transaction data packets based on type priorities respectively corresponding to the N transaction attribute types and the transaction attribute values, to obtain a transaction data packet sequence; respectively generating, for the N transaction attribute types, attribute value sets in the position order based on the transaction attribute values corresponding to a same transaction attribute type in the transaction data packet sequence, to obtain N attribute value sets; respectively performing incremental encoding on the N attribute value sets, to obtain N attribute value incremental encodings; and performing block encapsulation on the N attribute value incremental encodings, to obtain a pending block.

### RELATED APPLICATION

This application is a continuation of International Application No. PCT/CN2025/097787, filed May 28, 2025, which claims priority to Chinese Patent Application No. 2024109107402, entitled “BLOCKCHAIN-BASED BLOCK COMPRESSION METHOD AND APPARATUS, DEVICE, AND READABLE STORAGE MEDIUM” and filed with the China National Intellectual Property Administration on Jul. 8, 2024. The contents of International Application No. PCT/CN2025/097787 and Chinese Patent Application No. 2024109107402 are herein incorporated by reference in their entirety.

### FIELD OF THE TECHNOLOGY

This application relates to the technical field of computers, and in particular, to a blockchain-based block compression method and apparatus, a device, and a readable storage medium.

### BACKGROUND OF THE DISCLOSURE

A blockchain is a new application mode of computer technologies, such as distributed data storage, peer-to-peer transmission, a consensus mechanism, and an encryption algorithm. The blockchain is primarily configured to organize data in chronological order and encrypt the data into a ledger, to make the data tamper-proof and unforgeable, and to enable data validation, storage, and update.

Because of decentralization and multi-node features of a blockchain system, each blockchain node needs to store a complete copy of data on all blocks. A single block often requires a very large amount of space, and a volume of data stored on each blockchain node in the blockchain system continuously increases over time, resulting in exponentially increasing consumption of storage resources. This, in turn, continuously lowers data operation performance of the blockchain node, and further lowers performance of the entire blockchain system.

### SUMMARY

Embodiments of this application provide a blockchain-based block compression method and apparatus, a device, and a readable storage medium, to reduce storage space required by a block and improve performance of a blockchain system.

According to an aspect, embodiments of this application provide a blockchain-based block compression method, including:
obtaining M transaction data packets, each of the transaction data packets including transaction attribute values respectively corresponding to N transaction attribute types, and M and N being both positive integers;
determining position order of the M transaction data packets based on type priorities respectively corresponding to the N transaction attribute types and the transaction attribute values, to obtain a transaction data packet sequence;
respectively generating, for the N transaction attribute types, attribute value sets in the position order based on the transaction attribute values corresponding to a same transaction attribute type in the transaction data packet sequence, to obtain N attribute value sets;
respectively performing incremental encoding on the N attribute value sets, to obtain N attribute value incremental encodings; and
performing block encapsulation on the N attribute value incremental encodings, to obtain a pending block, the pending block being configured to be added to a blockchain when consensus is reached.

According to an aspect, embodiments of this application provide a blockchain-based block compression apparatus, including:
an obtaining module, configured to obtain M transaction data packets, each of the transaction data packets including transaction attribute values respectively corresponding to N transaction attribute types, and M and N being both positive integers;
a sorting module, configured to determine position order of the M transaction data packets based on type priorities respectively corresponding to the N transaction attribute types and the transaction attribute values, to obtain a transaction data packet sequence;
a classification module, configured to respectively generate, for the N transaction attribute types, attribute value sets in the position order based on the transaction attribute values corresponding to a same transaction attribute type in the transaction data packet sequence, to obtain N attribute value sets;
an encoding module, configured to respectively perform incremental encoding on the N attribute value sets, to obtain N attribute value incremental encodings; and
an encapsulation module, configured to perform block encapsulation on the N attribute value incremental encodings, to obtain a pending block, the pending block being configured to be added to a blockchain when consensus is reached.

According to an aspect, embodiments of this application provide a computer device, including: a processor, a memory, and a network interface.

The processor is connected to the memory and the network interface. The network interface is configured to provide a data communication network element. The memory is configured to store a computer program. The processor is configured to invoke the computer program to perform the method according to the embodiments of this application.

According to an aspect, embodiments of this application provide a computer-readable storage medium. The computer-readable storage medium stores a computer program. The computer program is adapted to be loaded and executed by a processor, to perform the method according to the embodiments of this application.

One aspect of the embodiments of this application provides a computer program product or a computer program. The computer program product or the computer program includes computer instructions. The computer instructions are stored in a computer readable storage medium. A processor of a computer device reads the computer instructions from the computer readable storage medium. The processor executes the computer instructions, so that the computer device executes the method in the embodiments of this application.

In the embodiments of this application, a blockchain node may obtain M transaction data packets, each transaction data packet including transaction attribute values of N transaction attribute types; determine position order of the M transaction data packets based on type priorities respectively corresponding to the N transaction attribute types and M transaction attribute values respectively corresponding to the N transaction attribute types, to obtain a transaction data packet sequence; respectively generate, for the N transaction attribute types, attribute value sets in the position order based on the transaction attribute values corresponding to a same transaction attribute type in the transaction data packet sequence, to obtain N attribute value sets; respectively perform incremental encoding on the N attribute value sets, to obtain N attribute value incremental encodings; and finally, perform block encapsulation on the N attribute value incremental encodings, to obtain a pending block, the pending block being configured to be added to a blockchain when consensus is reached. According to the method provided in the embodiments of this application, the transaction data packets may be first re-sorted based on the type priorities respectively corresponding to the transaction attribute types and the transaction attribute values. Such a sorting mechanism ensures that a transaction data packet with a small transaction attribute value change is prioritized in the incremental encoding phase. Therefore, high data redundancy elimination efficiency can be achieved in the incremental encoding phase. As a result, storage space required for a block is reduced, and performance of the blockchain system is enhanced.

### BRIEF DESCRIPTION OF THE DRAWINGS

To describe the technical solutions in the embodiments of this application or in the related art more clearly, the accompanying drawings required for describing the embodiments or the related art are briefly described below. Apparently, the accompanying drawings in the following description show some embodiments of this application, and a person of ordinary skill in the art may still derive other drawings from these accompanying drawings without creative efforts.

FIG. 1 is a schematic diagram of a network structure of a blockchain node system according to an embodiment of this application.

FIG. 2 is a schematic diagram of a scenario of a blockchain-based block compression method according to an embodiment of this application.

FIG. 3 is a schematic flowchart of a blockchain-based block compression method according to an embodiment of this application.

FIG. 4 is a schematic diagram of transaction position sorting according to an embodiment of this application.

FIG. 5 is a schematic flowchart of a blockchain-based priority determination method according to an embodiment of this application.

FIG. 6 is a schematic diagram of sliding of a type sliding window according to an embodiment of this application.

FIG. 7 is a diagram of a system architecture of a transaction incremental encoding block compression solution based on a sliding window and a dynamic standard deviation according to an embodiment of this application.

FIG. 8a is a schematic diagram of a transaction sorting process based on a sliding window and a dynamic standard deviation according to an embodiment of this application.

FIG. 8b is a schematic structural diagram of a multi-transaction attribute sliding window according to an embodiment of this application.

FIG. 9 is a schematic diagram of a block compression process based on transaction incremental encoding according to an embodiment of this application.

FIG. 10 is a schematic structural diagram of a blockchain-based block compression apparatus according to an embodiment of this application.

FIG. 11 is a schematic structural diagram of a computer device according to an embodiment of this application.

### DESCRIPTION OF EMBODIMENTS

The following clearly and completely describes the technical solutions in the embodiments of this application with reference to the accompanying drawings in the embodiments of this application. Apparently, the described embodiments are some of the embodiments of this application, rather than all of the embodiments. All other embodiments obtained by a person of ordinary skill in the art based on the embodiments of this application without creative efforts fall within the scope of protection of this application.

For ease of understanding, some terms are first briefly explained below.
1. Blockchain: In a narrow sense, the blockchain refers to a chained data structure with blocks as fundamental units. In a block, a previously obtained transaction history is validated by using a digital digest, which meets requirements for tamper-proofing and scalability in a distributed ledger scenario. In a broad sense, the blockchain also refers to a distributed ledger technology implemented by the blockchain structure, including distributed consensus, privacy and security protection, a peer-to-peer communication technology, a network protocol, a smart contract, and the like.

An objective of the blockchain is to implement a distributed ledger for recording data, which is append-only and does not permit deletion. A basic underlying structure of the account book is a linear linked list. The linked list is formed by concatenating “blocks” one by one. A succeeding block records a Hash value of a preceding block. Whether each block (and a transaction in the block) is legal may be quickly checked by calculating a Hash value. If a node in a network proposes to add a new block, consensus confirmation on the blocks needs to be reached based on a consensus mechanism.
2. Block: The block refers to a data packet carrying transaction data on a blockchain network and is a data structure marked with a timestamp and a hash value of a preceding block. The block verifies and determines transactions in blocks based on a consensus mechanism of the network. The block includes a block header and a block body. The block header may record metadata of the current block, including data such as a current version number, a hash value corresponding to a preceding block, a timestamp, a random number, and a hash value of a Merkle Root. The block body may record detailed data generated in a period of time, including all transaction records of the current block that are verified and that are generated during creation of the block, or other information, and may be understood as a representation form of a ledger. In addition, the detailed data of the block body may include a hash process of a Merkle tree, which generates a unique Merkle root that is recorded in the block header.

The preceding block is also referred to as a parent block. The blockchain records a hash value corresponding to the block and a hash value corresponding to the parent block in the block header to implement chronological sorting.
3. Hash value: The hash value is alternatively referred to as an information feature value or a feature value. The hash value is generated by converting input data of any length into a cryptographic digest by using a hash algorithm and producing an output of a fixed length. The original input data cannot be retrieved by decrypting the hash value because the hash algorithm is a one-way encryption function. In the blockchain, each block (except for the genesis block) includes a hash value of a preceding block. The hash value is the potential core foundation and the most critical aspect of the blockchain technology, as it preserves authenticity of recorded and viewed data, as well as integrity of the blockchain as a whole.
4. Smart contract: The smart contract refers to a computer protocol that is designed to propagate, verify, or execute a contract in an information-based manner. The concept of the smart contract has three main elements: a promise, a protocol, and a digital form. Therefore, an application range of the blockchain can be extended to various links of transaction, payment, settlement, and clearing in the financial industry. The smart contract is a contract that automatically executes its terms when a pre-programmed condition is triggered, and a working principle of the smart contract is similar to an if-then statement of a computer program. The smart contract allows trustworthy transactions to be performed without a third party, and these transactions are traceable and irreversible.
5. State data: The state data refers to a data structure in a blockchain system that is configured for representing a current state of the system. The state data includes balances of all accounts, a state of a smart contract, and other related information. The state data is continuously updated as a transaction data packet is executed, and reflects a global state of the blockchain system at a time point. In the blockchain system, the state data is typically stored in the form of a Merkle tree or another encrypted data structure, to ensure integrity and security of the state data.
6. Transaction pool: The transaction pool (also referred to as an internal memory pool or mempool) is a data structure in a blockchain network, and is configured for storing a pending transaction that is not packaged into a block. When a user submits a new transaction to the blockchain network, the transaction first enters the transaction pool. When preparing to generate a new block, a blockchain node selects a particular quantity of transactions from the transaction pool for packaging. The transaction pool helps improve a processing capability of the blockchain network.
7. Sliding window: The sliding window is a data processing technique configured for creating a dynamic subset in a series of data points. The subset includes data points before and after a current processing point. During processing of a blockchain transaction, the sliding window may be configured for continuously detecting and analyzing recent transaction data. The window “slides” as a new transaction data packet is added, to be specific, a new transaction is added to one end of the window, and an old transaction is removed from the other end of the window. This method allows the system to dynamically detect a change in transaction data, to facilitate implementation of various optimization policies, such as transaction sorting or data compression.
8. Dynamic variance: The dynamic variance refers to a measure of a variance (namely, an average value of a square of a difference between a data point and an average value of the data point) of a data point that dynamically changes over time in a time window. In blockchain transaction data, the dynamic variance may be configured for measuring a change degree of a particular attribute (such as a transaction amount and an address of a transaction party) in a recent period of time. By calculating the dynamic variance, a system may identify attributes with small changes (namely, small variances), and these attributes are more easily compressed during incremental encoding because of high continuity of the attributes.
9. Incremental encoding: Incremental encoding is a data compression technique in which only a changed part in a data sequence is stored, rather than storing a complete data point each time. In a blockchain transaction, incremental encoding may be configured for reducing redundancy of storing same or similar transaction data. For example, if consecutive transactions come from a same transmitter, when these transactions are stored, an address of the transmitter may be stored only once, and a tag or a reference only needs to be stored in a subsequent transaction, to indicate that the field is identical to that in a previous transaction.
10. Block compression: Block compression refers to a process of compressing block data in a blockchain, to reduce space required for storage and transmission. A block typically includes a plurality of transactions, and each transaction includes a plurality of fields. By using a data compression algorithm such as incremental encoding, a size of the block can be reduced, storage costs are reduced, and network transmission efficiency is improved. Block compression is crucial for enhancing scalability and performance of the blockchain, especially in a public blockchain network that processes a large quantity of transaction data packets.

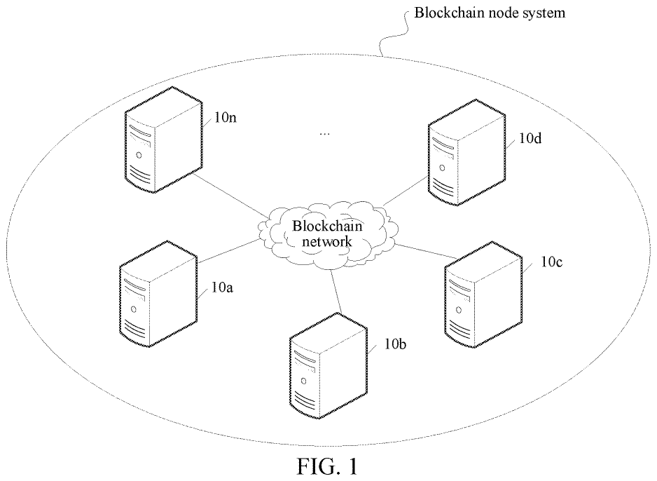

FIG. 1 is a schematic diagram of a network structure of a blockchain node system according to an embodiment of this application. The blockchain network shown in FIG. 1 may include, but is not limited to, a blockchain network corresponding to a consortium blockchain. The blockchain network may include a plurality of blockchain nodes. The plurality of blockchain nodes may specifically include a blockchain node 10a, a blockchain node 10b, a blockchain node 10c, a blockchain node 10d, . . . , and a blockchain node 10n. During normal operation, each blockchain node may receive data transmitted from external sources, and add a block to the chain based on the received data, or may transmit data to the external sources. To ensure intercommunication of data between the blockchain nodes, a data connection may exist between the blockchain nodes. For example, a data connection exists between the blockchain node 10a and the blockchain node 10b, a data connection exists between the blockchain node 10a and the blockchain node 10c, and a data connection exists between the blockchain node 10b and the blockchain node 10c.

The data connection is not limited to a connection manner, and may be implemented directly or indirectly by using a wired communication protocol, or implemented directly or indirectly by using a wireless communication protocol, or implemented in another connection manner. This is not limited in this application.

Data or block transmission may be performed between the blockchain nodes through the data connection. The blockchain network may achieve the data connection between the blockchain nodes based on node identifiers. Each blockchain node in the blockchain network has a corresponding node identifier, and each blockchain node can store a node identifier of another blockchain node connected to the blockchain node. In this way, the blockchain node broadcasts obtained data or a generated block to still another blockchain node based on the node identifier of the another blockchain node subsequently. For example, a node identifier list shown in Table 1 may be maintained in the blockchain node 10a. The node identifier list stores node names and node identifiers of other nodes.

TABLE 1

| Node name | Node identifier |
|---|---|
| Node 10a | AAA.AAA.AAA.AAA |
| Node 10b | BBB.BBB.BBB.BBB |
| Node 10c | CCC.CCC.CCC.CCC |
| Node 10d | DDD.DDD.DDD.DDD |
| . . . | ... |
| Node 10n | EEE.EEE.EEE EEE |

The node identifier may be an Internet protocol (IP) address and any other piece of information capable of identifying the node in the blockchain network. In Table 1, a description is made by using only the IP address as an example. For example, the blockchain node 10a can transmit information (such as a block) to the blockchain node 10b based on the node identifier BBB.BBB.BBB.BBB, and the blockchain node 10b can determine that the information is transmitted by the blockchain node 10a based on the node identifier AAA.AAA.AAA.AAA.

In the blockchain, before being added to the chain, a single block needs to undergo consensus among consensus nodes in the blockchain network, and can be added to the blockchain only after consensus is reached. When the blockchain is applied to some scenarios involving government or commercial institutions, not all participating nodes (namely, the blockchain nodes in the blockchain network) in the blockchain have sufficient resources and necessity to become the consensus nodes in the blockchain. For example, in the blockchain network shown in FIG. 1, the blockchain node 10a, the blockchain node 10b, the blockchain node 10c, and the blockchain node 10d may be used as the consensus nodes in the blockchain network. The consensus nodes within the blockchain network participate in consensus, that is, engage in consensus on the block (including a batch of transactions), to be specific, vote on the block. Non-consensus node does not participate in consensus, but helps propagate the block and a vote message, as well as synchronize mutual states, and the like.

A single block often requires a very large amount of space, and a volume of data stored on each blockchain node within the blockchain system continuously increases over time. Therefore, this application provides a blockchain-based block compression method. Transaction data packets are sorted, and a transaction with a small transaction attribute value change is prioritized for processing and compression. This achieves high data redundancy elimination efficiency and reduces storage space required for a block. Specifically, when satisfying a block generation condition, any blockchain node in the blockchain network may obtain M transaction data packets, M being a positive integer, a single transaction data packet including transaction attribute values of N transaction attribute types, and N being a positive integer; perform position sorting on the M transaction data packets based on type priorities respectively corresponding to the N transaction attribute types and M transaction attribute values respectively corresponding to the N transaction attribute types, to obtain a transaction data packet sequence; add transaction attribute values of a same transaction attribute type in the transaction data packet sequences to a same attribute value set in position order of the transaction data packet sequence, to obtain attribute value sets respectively corresponding to the N transaction attribute types; respectively perform incremental encoding on the N attribute value sets, to obtain N attribute value incremental encodings; and finally, perform block encapsulation on the N attribute value incremental encodings, to obtain a pending block, the pending block being configured to be added to the blockchain when consensus is reached.

The data connection is not limited to a connection manner, and may be implemented directly or indirectly by using a wired communication protocol, or implemented directly or indirectly by using a wireless communication protocol, or implemented in another connection manner. This is not limited in this application.

The block compression method provided in the embodiments of this application may be performed by a computer device. The computer device includes, but is not limited to, a blockchain node (which may be a terminal or a server). The server may be an independent physical server, or a server cluster or distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be, but is not limited to, a smartphone, a tablet computer, a notebook computer, a desktop computer, a smart speaker, a smartwatch, or the like.

The embodiments of this application may be applied to various application scenarios, which include, but are not limited to, cloud technologies, artificial intelligence, intelligent driving, supply chain management, Internet of Things (IoT) data storage, cross-platform or cross-region remittance, and the like.

For example, the embodiments of this application may be applied to supply chain management. In supply chain management, a blockchain is configured for recording each link from production to consumption of a commodity. The information usually includes a large amount of repeated data, such as supplier information and a batch number. The embodiments of this application may be applied to these systems. Transaction data in a block is compressed, to improve data storage and query efficiency. In addition, this ensures transparency and untamperability of a supply chain.

For another example, the embodiments of this application may be applied to IoT data storage. An IoT device usually generates a large amount of data, and a blockchain may provide a secure storage and sharing platform for the data. The embodiments of this application may be applied to blockchain storage of IoT data. Similar data frequently exchanged between devices is compressed, to reduce storage demands and improve data transmission efficiency. This is particularly important for IoT application with limited bandwidth and high demands for real-time data processing.

In a specific implementation of this application, relevant data, such as transactions and transaction attribute values, are involved. When the embodiments of this application are applied to a specific product or technology, permission or consent of users needs to be obtained, and collection, use, and processing of the relevant data need to comply with relevant laws, regulations, and standards of relevant countries and regions.

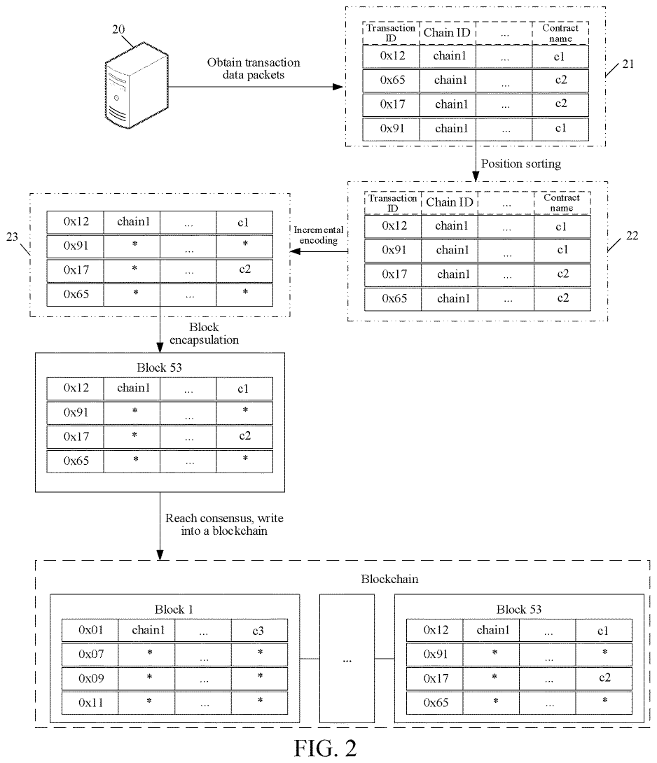

To facilitate understanding of the foregoing block encoding and compression process, FIG. 2 is a schematic diagram of a scenario of a blockchain-based block compression method according to an embodiment of this application. A blockchain node 20 shown in FIG. 2 may be any blockchain node in the foregoing blockchain network. For example, the blockchain node 20 may be the blockchain node 10a.

As shown in FIG. 2, when the blockchain node 20 satisfies a block generation condition, that is, the blockchain node 20 is a block generation node in a current round, the blockchain node 20 may obtain a transaction data packet 21 from a transaction pool. It is assumed that the obtained transaction data packet 21 includes a transaction 0x12 (namely, a transaction whose transaction ID is 0x12), a transaction 0x65 (namely, a transaction whose transaction ID is 0x65), a transaction 0x17 (namely, a transaction whose transaction ID is 0x17), and a transaction 0x91 (namely, a transaction whose transaction ID is 0x91). A single transaction may include a plurality of transaction attribute values of different transaction attribute types. For example, a single transaction needs to include transaction attribute values of transaction attribute types such as a transaction ID, a chain ID, . . . , and a contract name. Transaction attribute values of many transaction attribute types may repeatedly occur in a plurality of consecutive transactions. For example, for a chain ID, when only one blockchain exists in the blockchain network, all transactions generated in the blockchain network include a same chain ID, and repeatedly storing the chain ID of each transaction data packet may cause unnecessary space waste.

Therefore, before encoding and compressing the transactions, the blockchain node 20 may first perform position sorting on the transaction data packet 21 based on type priorities respectively corresponding to the transaction attribute types and transaction attribute values corresponding to the transaction attribute types, to obtain positionally sorted transactions 22. The type priority corresponding to the transaction attribute type may be configured for representing a change degree of the transaction attribute value corresponding to the transaction attribute type. A higher type priority corresponding to the transaction attribute type indicates a smaller change degree of the transaction attribute value corresponding to the transaction attribute type. That is, among the plurality of transactions, transaction attribute values corresponding to the transaction attribute type with a high type priority have a high probability of including duplicate data.

As shown in FIG. 2, it is assumed that the chain ID has a priority of 1, the contract name has a priority of 2, . . . , and a transaction ID has a priority of n. When sorting the transaction data packet 21, the blockchain node 20 may first sort the transactions in the transaction data packet 21 based on transaction attribute values corresponding to the chain ID, to obtain transactions after 1^{st} sorting, then sort the first sorted transactions based on transaction attribute values corresponding to the contract name, to obtain transactions after 2^{nd} sorting, . . . , and finally sort, based on transaction attribute values corresponding to the transaction ID, transactions obtained after (n−1)^{th} sorting, to obtain the positionally sorted transactions 22. When the transactions are sorted based on transaction attribute values corresponding to a transaction attribute type with a low type priority, a sorting result of transaction attribute values corresponding to a transaction attribute type with a high type priority that are included in the transactions before sorting needs to remain consistent with a sorting result of the transaction attribute values corresponding to the transaction attribute type with the high type priority that are included in the transactions. For example, after the transactions obtained after 1^{st} sorting are sorted based on the transaction attribute values corresponding to the contract name, the following transactions are sequentially obtained after 2^{nd} sorting: the transaction 0x12, the transaction 0x91, the transaction 0x65, and the transaction 0x17. In this case, a sorting result of the transaction attribute values corresponding to the contract name that are included in the transactions is [c1, c1, c2, c2]. Then, the transactions obtained after (n−1)^{th} sorting are sorted based on the transaction attribute values corresponding to the transaction ID, and the following positionally sorted transactions 22 are sequentially obtained: the transaction 0x12, the transaction 0x91, the transaction 0x17, and the transaction 0x65. In this case, the sorting result of the transaction attribute values corresponding to the contract name that are included in the transactions is still [c1, c1, c2, c2].

As shown in FIG. 2, after obtaining the positionally sorted transactions 22, the blockchain node 20 may perform incremental encoding on the positionally sorted transaction 22. That is, the blockchain node 20 may respectively perform incremental encoding on the transaction attribute values of different transaction attribute types, to obtain attribute value incremental encodings 23. For example, for the transaction attribute values of the chain ID, the blockchain node 20 performs incremental encoding on the transaction attribute values, to obtain the following incremental encoding of the chain ID: [chain1, *, *, *]. For the transaction attribute values of the contract name, the blockchain node 20 performs incremental encoding on the transaction attribute values, to obtain the following incremental encoding of the contract name: [c1, *, c2, *]. Finally, the blockchain node 20 may perform block encapsulation on the attribute value incremental encodings 23, to obtain a block 53. Then, the blockchain node 20 may transmit the block 53 to another blockchain node in the blockchain network. After determining that consensus is reached on the block 53, the blockchain node 20 may write the block 53 into the blockchain.

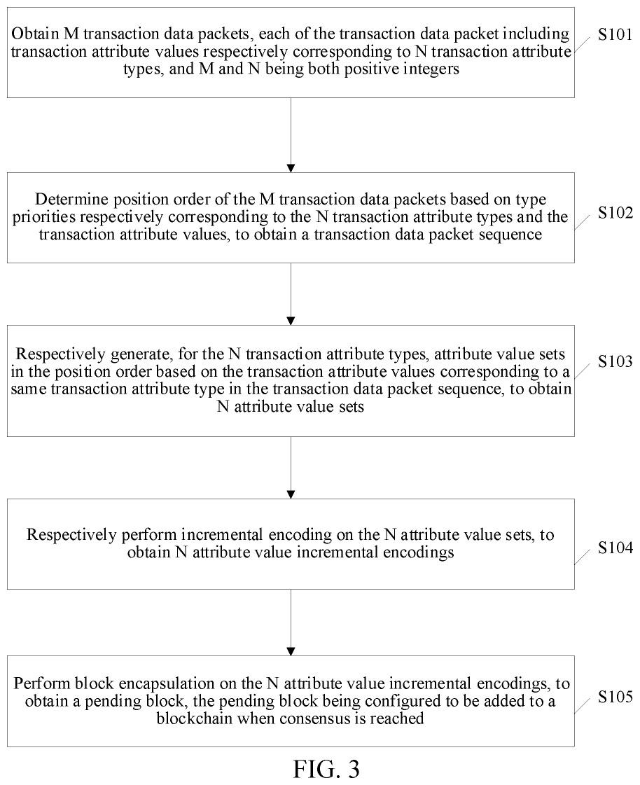

Description of embodiments corresponding to FIG. 3 and FIG. 5 relate to implementations of the process of performing position sorting on the transaction data packet and the process of performing incremental encoding on the transaction data packet subjected to position sorting.

FIG. 2 demonstrates that according to the block compression method provided in the embodiments of this application, the transactions may be re-sorted based on the type priorities corresponding to the transaction attribute types and the transaction attribute values corresponding to the transaction attribute types. Based on such a sorting mechanism, duplicate transaction attribute values included in the plurality of transactions can be grouped together as much as possible. In this way, high data redundancy elimination efficiency is achieved in the subsequent incremental encoding phase, to reduce storage space required for the block and enhance performance of the blockchain system.

Further, FIG. 3 is a schematic flowchart of a blockchain-based block compression method according to an embodiment of this application. The method may be performed by a blockchain node (which is, for example, any blockchain node in the blockchain network in the embodiment corresponding to FIG. 1, such as the blockchain node 10a). A description is made below by using an example in which the method is performed by a blockchain node. The blockchain-based block compression method may at least include operation S101 to operation S105.

Operation S101: Obtain M transaction data packets, each of the transaction data packets including transaction attribute values respectively corresponding to N transaction attribute types, and M and N being both positive integers.

Specifically, a transaction data packet refers to pending transactions that are not packaged into a block, and is usually stored in a transaction pool. When a user submits a new transaction to the blockchain network, the transaction first enters the transaction pool. When preparing to generate a new block, a blockchain node selects a particular quantity of transactions from the transaction pool for packaging. The particular quantity of transactions refer to the M transaction data packets in this application. M is determined by a block configuration of a current blockchain. For example, a single block in the current blockchain may include 100 transactions, and M is equal to 100.

Specifically, to facilitate understanding of a transaction structure of the transaction data packet, Table 2 provides a feasible example of the transaction structure.

TABLE 2

| | | | Signature | | | | | | |
|---|---|---|---|---|---|---|---|---|---|
| | | Identity of | of | | | | | | |
| Transaction | | transaction | transaction | Chain | Contract | Contract | Contract | Contract | Contract |
| ID | Timestamp | transmitter | transmitter | ID | name | method | parameter | read set | write set |
| 0x12 | 1762541 | Alice | sig1 | chain1 | c1 | set | a, 100 | / | a, 100 |
| 0x65 | 1762551 | Alice | sig2 | chain1 | c1 | set | b, 80 | / | b, 80 |
| 0xa9 | 1762584 | Alice | sig5 | chain1 | c1 | get | a | a | / |

Table 2 shows that a single transaction data packet may include transaction attribute values of 10 transaction attribute type. Transaction attribute values of a same transaction attribute type that are included in different transaction data packets may be identical. For example, in the foregoing three transaction data packets, the transaction attribute values of the transaction attribute type that is the identity of the transaction transmitter are all Alice, and the transaction attribute values of the transaction attribute type that is the contract name are all c1. That is, the transaction attribute values corresponding to the transaction attribute types, such as the address, the contract name, and the identity of the transaction transmitter, may repeatedly occur in the obtained M transaction data packets. In the conventional block storage solution, the same data is usually stored repeatedly, resulting in an unnecessary waste of storage space.

Operation S102: Determine position order of the M transaction data packets based on type priorities respectively corresponding to the N transaction attribute types and the transaction attribute values, to obtain a transaction data packet sequence.

Specifically, to effectively compress transaction attribute values repeatedly occurring in the M transaction data packets, the blockchain node may perform position sorting on the M transaction data packets, to rank transactions with small transaction attribute value changes as front as possible without affecting integrity and accessibility of the transaction data packets. This achieves high data redundancy elimination efficiency in the subsequent incremental encoding phase.

Specifically, the type priority is configured for representing a probability that a transaction attribute value corresponding to a transaction attribute type changes across the M transaction data packets. The type priority may be set based on manual experience, that is, the type priority may be preset, or may be set according to a change situation (for example, a dynamic variance or dynamic standard deviation corresponding to a transaction attribute value is calculated, and the change situation is reflected by the dynamic variance or the dynamic standard deviation) of a transaction attribute value corresponding to each transaction attribute type in transactions generated within a period of time. This is not limited in this application. A higher (ranked earlier) type priority indicates a lower possibility that a transaction attribute value that corresponds to a transaction attribute type corresponding to the type priority changes across the M transaction data packets. Therefore, when sorting the M transaction data packets, the blockchain node needs to prioritize a transaction attribute type with a highest type priority, that is, group transaction data packets including a same transaction attribute value corresponding to the transaction attribute type with highest type priority together as much as possible, and then sort a transaction attribute type with a second highest type priority.

In an embodiment, the type priorities respectively corresponding to the N transaction attribute types may be determined based on change probabilities of the transaction attribute values of the N transaction attribute types. That is, a lower change probability of a transaction attribute value of a transaction attribute type indicates a higher type priority corresponding to the transaction attribute type. A higher change probability of a transaction attribute value of a transaction attribute type indicates a lower type priority corresponding to the transaction attribute type. The change probability of the transaction attribute value of the transaction attribute type reflects a probability that the transaction attribute value corresponding to the transaction attribute type changes across the M transaction data packets, and the change probability of the transaction attribute value of each transaction attribute type may be determined based on at least one of a dynamic variance or a dynamic standard deviation of the transaction attribute value corresponding to each transaction attribute type in transactions generated within a period of time. The period of time herein may refer to a historical period of time, or the period of time may refer to a current period of time. For example, the change probability of the transaction attribute value may be determined based on the transaction attribute values in the M transaction data packets.

Specifically, a feasible implementation process of determining position order of the M transaction data packets based on the type priorities respectively corresponding to the N transaction attribute types and the transaction attribute values, to obtain a transaction data packet sequence may be: traversing the N transaction attribute types based on the type priorities respectively corresponding to the N transaction attribute types, to obtain a k^{th} transaction attribute type, a type priority corresponding to the k^{th} transaction attribute type being lower than a type priority corresponding to an obtained (k−1)^{th} transaction attribute type; performing, based on M transaction attribute values corresponding to the k^{th} transaction attribute type, k^{th} position sorting on M candidate transaction data packets obtained after (k−1)^{th} position sorting, to obtain M candidate transaction data packets after k^{th} position sorting, the M candidate transaction data packets obtained after (k−1)^{th} position sorting being the M transaction data packets when k is 1; and further obtaining a (k+1)^{th} transaction attribute type if the M transaction attribute values corresponding to the k^{th} transaction attribute type include identical transaction attribute values, and performing, based on M transaction attribute values corresponding to the (k+1)^{th} transaction attribute type, (k+1)^{th} position sorting on the M candidate transaction data packets obtained after k^{th} position sorting; or stopping traversal of the N transaction attribute types if the M transaction attribute values corresponding to the k^{th} transaction attribute type do not include transaction attribute values that are identical and are consecutive in position, and determining the M candidate transaction data packets obtained after k^{th} position sorting as the transaction data packet sequence. The transaction data packets are sequentially sorted in descending order of type priority, which helps arrange transaction data packets including a largest amount of identical transaction data in the transaction data packets in consecutive adjacent positions. Further, this facilitates incremental encoding, reduces data redundancy, and enhances blockchain performance. A feasible implementation process of performing k^{th} position sorting, based on M transaction attribute values corresponding to the k^{th} transaction attribute type, M candidate transaction data packets obtained after (k−1)^{th} position sorting, to obtain M candidate transaction data packets after k^{th} position sorting may be: performing attribute value sorting on the M transaction attribute values corresponding to the k^{th} transaction attribute type, to obtain M sorted transaction attribute values; determining candidate transaction data packets in the M candidate transaction data packets obtained after (k−1)^{th} position sorting that include identical first transaction attribute values and that are consecutive in position as to-be-adjusted candidate transaction data packets, the first transaction attribute value being a transaction attribute value of the (k−1)^{th} transaction attribute type, and the to-be-adjusted candidate transaction data packets being the M transaction data packets when k is 1; and performing position adjustment on the to-be-adjusted candidate transaction data packets in the M candidate transaction data packets based on a position relationship among second transaction attribute values included in the to-be-adjusted candidate transaction data packets in the M sorted transaction attribute values, to obtain the M candidate transaction data packets after k^{th} position sorting, the second transaction attribute value being a transaction attribute value of the k^{th} transaction attribute type. Such actions may help arrange identical transaction attribute values of each transaction attribute type in consecutive adjacent positions as much as possible, which may facilitate incremental encoding, reduce data redundancy, and enhance blockchain performance.

In some embodiments, attribute value sorting is performed on the M transaction attribute values corresponding to the k^{th} transaction attribute type, to obtain M sorted transaction attribute values includes that: statistics collection is performed on a quantity of identical transaction attribute values in the M transaction attribute values corresponding to the k^{th} transaction attribute type; and the identical transaction attribute values are arranged in consecutive adjacent positions in descending order of the quantity of identical transaction attribute values, and different transaction attribute values are sorted in lexicographical order, to obtain the M sorted transaction attribute values. In this way, the identical transaction attribute values are replaced with a special encoding symbol, and the entire transaction attribute value does not need to be repeatedly stored. This can avoid unnecessary waste of storage space, reduce data redundancy, and enhance performance of the blockchain system.

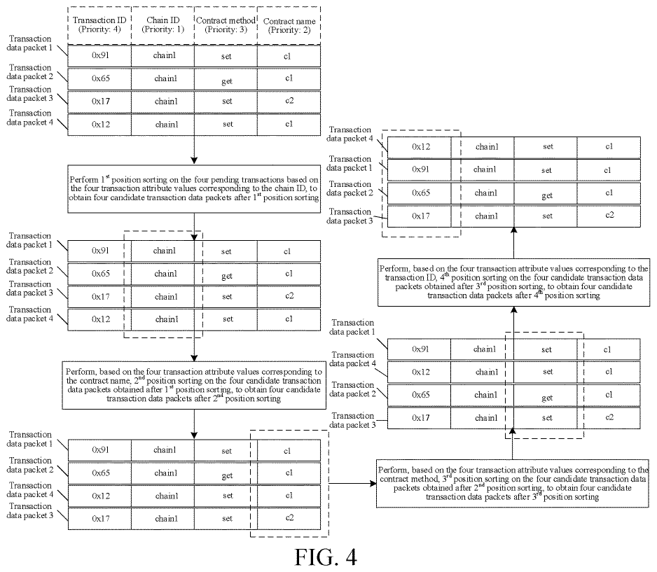

To facilitate understanding of the foregoing process of performing position sorting on the M transaction data packets, FIG. 4 is a schematic diagram of transaction position sorting according to an embodiment of this application. As shown in FIG. 4, it is assumed that a blockchain node (not shown in the figure but may be any blockchain node in the foregoing blockchain network shown in FIG. 1, such the blockchain node 10b for example) needs to perform position sorting on four transaction data packets, namely, a transaction data packet 41, a transaction data packet 42, a transaction data packet 43, and a transaction data packet 44. A single transaction data packet includes transaction attribute values of four transaction attribute types. The four transaction attribute types may be a transaction ID, a chain ID, a contract method, and a contract name. The transaction ID corresponds to a type priority of 4, the chain ID corresponds to a type priority of 1, the contract method corresponds to a type priority of 3, and the contract name corresponds to a type priority of 2. That is, the type priority corresponding to the chain ID>the type priority corresponding to the contract name>the type priority corresponding to the contract method>the type priority corresponding to the transaction ID. Therefore, when the blockchain node traverses the four transaction attribute types based on the type priorities respectively corresponding to the four transaction attribute types, the 1^{st} obtained transaction attribute type is the chain ID.

As shown in FIG. 4, the blockchain node performs 1^{st} position sorting on the four transaction data packets based on four transaction attribute values corresponding to the chain ID, to obtain four candidate transaction data packets after 1^{st} position sorting. A specific process of 1^{st} position sorting may be: performing attribute value sorting on the four transaction attribute values corresponding to the chain ID, to obtain four sorted chain ID transaction attribute values; and performing position adjustment on the four transaction data packets based on a position relationship among the four sorted chain ID transaction attribute values, to obtain four candidate transaction data packets after 1^{st} position sorting. Attribute value sorting may be performed through lexicographical sorting. Lexicographic sorting is also referred to as lexicographic ordering, which is a sorting method performed based on alphabetical order of characters or digits. In computer science, lexicographic sorting generally refers to sorting comparable objects, such as character strings, characters, or digits, in lexicographical order. A basic principle of such a sorting method is that: if two objects have different characters at a position, the two objects are sorted in alphabetical order of the characters at the position. To be specific, a smaller character is sorted in the front and a larger character is sorted in the back. If the comparison reaches the end of one object, a shorter string or object is sorted in the front. If the two objects are completely identical, lexicographical order of the two objects is identical. FIG. 4 shows that the four transaction attribute values corresponding to the chain ID are all chain1. Therefore, positions of the obtained four sorted chain ID transaction attribute values do not change. Correspondingly, the four candidate transaction data packets obtained after 1^{st} position sorting are sequentially: the transaction data packet 41, the transaction data packet 42, the transaction data packet 43, and the transaction data packet 44.

As shown in FIG. 4, when the blockchain node traverses the four transaction attribute types based on the type priorities respectively corresponding to the four transaction attribute types, the 2^{nd} obtained transaction attribute type is the contract name. The blockchain node performs, based on four transaction attribute values corresponding to the contract name, 2^{nd} position sorting on the four candidate transaction data packets obtained after 1^{st} position sorting, to obtain four candidate transaction data packets after 2^{nd} position sorting. A specific process of 2^{nd} position sorting may be: first, performing attribute value sorting on the four transaction attribute values corresponding to the contract name, to obtain four sorted contract name transaction attribute values, which are sequentially: c1 included in the transaction data packet 41, c1 included in the transaction data packet 42, c1 included in the transaction data packet 44, and c2 included in the transaction data packet 43. Because the transaction attribute values corresponding to the chain ID that are included in the four candidate transaction data packets obtained after 1^{st} position sorting are all chain1, the four candidate transaction data packets obtained after 1^{st} position sorting are all to-be-adjusted candidate transaction data packets. In this case, the blockchain node performs position adjustment on the to-be-adjusted candidate transaction data packets based on a position relationship among the transaction attribute values corresponding to the contract name that are included in to-be-adjusted candidate transaction data packets in the four sorted contract name transaction attribute values, to obtain four candidate transaction data packets after 2^{nd} position sorting, which are sequentially: the transaction data packet 41, the transaction data packet 42, the transaction data packet 44, and the transaction data packet 43.

As shown in FIG. 4, when the blockchain node traverses the four transaction attribute types based on the type priorities respectively corresponding to the four transaction attribute types, the 3^{rd} obtained transaction attribute type is the contract method. The blockchain node performs, based on four transaction attribute values corresponding to the contract method, 3^{rd} position sorting on the four candidate transaction data packets obtained after 2^{nd} position sorting, to obtain four candidate transaction data packets after 3^{rd} position sorting. A specific process of 3^{rd} position sorting may be: first, performing attribute value sorting on the four transaction attribute values corresponding to the contract method, to obtain four sorted contract method transaction attribute values, which are sequentially: set included in the transaction data packet 41, set included in the transaction data packet 44, set included in the transaction data packet 43, and get included in the transaction data packet 42. Because among the four candidate transaction data packets obtained after 2^{nd} position sorting, only the transaction attribute values corresponding to the contract name that are included in the transaction data packet 41, the transaction data packet 42, and the transaction data packet 44 are identical and are consecutive in position, the blockchain node determines only the transaction data packet 41, the transaction data packet 42, and the transaction data packet 44 in the four candidate transaction data packets obtained after 2^{nd} position sorting as to-be-adjusted candidate transaction data packets for 3^{rd} position sorting. In this case, the blockchain node may perform, based on a position relationship among the transaction attribute values corresponding to the contract method that are included in the to-be-adjusted candidate transaction data packets in the four sorted contract name transaction attribute values, position adjustment on the to-be-adjusted candidate transaction data packets for 3^{rd} position sorting. To be specific, among the four sorted contract name transaction attribute values, set included in the transaction data packet 41 is located before set included in the transaction data packet 44, and set included in the transaction data packet 44 is located before get included in the transaction data packet 42. Therefore, after position adjustment, the transaction data packet 41 is located before the transaction data packet 44, and the transaction data packet 44 is located before the transaction data packet 42. In this way, the four candidate transaction data packets obtained after 3^{rd} position sorting are sequentially: the transaction data packet 41, the transaction data packet 44, the transaction data packet 42, and the transaction data packet 43.

As shown in FIG. 4, when the blockchain node traverses the four transaction attribute types based on the type priorities respectively corresponding to the four transaction attribute types, the 4^{th} obtained transaction attribute type is the transaction ID. The blockchain node performs, based on four transaction attribute values corresponding to the transaction ID, 4^{th} position sorting on the four candidate transaction data packets obtained after 3^{rd} position sorting, to obtain four candidate transaction data packets after 4^{th} position sorting. A specific process of 4^{th} position sorting may be: first, performing attribute value sorting on the four transaction attribute values corresponding to the transaction ID, to obtain four sorted transaction ID transaction attribute values, which are sequentially: 0x12 included in the transaction data packet 44, 0x17 included in the transaction data packet 43, 0x65 included in the transaction data packet 42, and 0x91 included in the transaction data packet 41. Because among the four candidate transaction data packets obtained after 3^{rd} position sorting, only the transaction attribute values corresponding to the contract name that are included in the transaction data packet 41 and the transaction data packet 44 are identical and are consecutive in position, the blockchain node determines only the transaction data packet 41 and the transaction data packet 44 in the four candidate transaction data packets obtained after 3^{rd} position sorting as to-be-adjusted candidate transaction data packets for 4^{th} position sorting. In this case, the blockchain node performs position adjustment on the to-be-adjusted candidate transaction data packets for 4^{th} position sorting based on a position relationship among the transaction attribute values corresponding to the transaction ID that are included in the to-be-adjusted candidate transaction data packets in the four sorted contract name transaction attribute values. To be specific, among the four sorted contract name transaction attribute values, 0x12 included in the transaction data packet 44 is located before 0x91 included in the transaction data packet 41. Therefore, after position adjustment, the transaction data packet 44 is located before the transaction data packet 41. In this way, the four candidate transaction data packets obtained after 4^{th} position sorting are sequentially: the transaction data packet 44, the transaction data packet 41, the transaction data packet 42, and the transaction data packet 43.

After completing traversal of the four transaction attribute types, the blockchain node determines the four candidate transaction data packets obtained after the last position sorting as four positionally sorted transactions, which are sequentially: the transaction data packet 44, the transaction data packet 41, the transaction data packet 42, and the transaction data packet 43.

In an embodiment, a feasible implementation process of performing, based on M transaction attribute values corresponding to the k^{th} transaction attribute type, k^{th} position sorting on M candidate transaction data packets obtained after (k−1)^{th} position sorting, to obtain M candidate transaction data packets after k^{th} position sorting may be: determining candidate transaction data packets in the M candidate transaction data packets obtained after (k−1)^{th} position sorting that include identical first transaction attribute values and that are consecutive in position as to-be-adjusted candidate transaction data packets, the first transaction attribute value being a transaction attribute value of the (k−1)^{th} transaction attribute type, and the to-be-adjusted candidate transaction data packets being the M transaction data packets when k is 1; performing attribute value sorting on second transaction attribute values included in the to-be-adjusted candidate transaction data packets, to obtain sorted second transaction attribute values; and performing position adjustment on the to-be-adjusted candidate transaction data packets in the M candidate transaction data packets based on an attribute value position relationship among the sorted second transaction attribute values, to obtain the M candidate transaction data packets after k^{th} position sorting, the second transaction attribute value being a transaction attribute value of the k^{th} transaction attribute type. For example, when the blockchain node shown in FIG. 4 performs, based on four transaction attribute values corresponding to the contract method, 4^{th} position sorting on the four candidate transaction data packets obtained after 3^{rd} position sorting, to obtain four candidate transaction data packets after 4^{th} position sorting. A specific process of 4^{th} position sorting may be that: The blockchain node first determines to-be-adjusted candidate transaction data packets. Because among the four candidate transaction data packets obtained after 3^{rd} position sorting, only the transaction attribute values corresponding to the contract name that are included in the transaction data packet 41 and the transaction data packet 44 are identical and are consecutive in position, the blockchain node determines only the transaction data packet 41 and the transaction data packet 44 in the four candidate transaction data packets obtained after 3^{rd} position sorting as the to-be-adjusted candidate transaction data packets for 4^{th} position sorting. Then, the blockchain node performs attribute value sorting on the transaction attribute values corresponding to the transaction ID that are included in the transaction data packet 41 and the transaction data packet 44, to obtain sorted transaction ID transaction attribute values, which are sequentially: 0x12 included in the transaction data packet 44 and 0x91 included in the transaction data packet 41. Based on a position relationship among the sorted transaction ID transaction attribute values, the blockchain node adjusts the transaction data packet 44 to a position before the transaction data packet 41. Therefore, the four candidate transaction data packets obtained after 4^{th} position sorting are sequentially: the transaction data packet 44, the transaction data packet 41, the transaction data packet 42, and the transaction data packet 43.

Operation S103: Respectively generate, for the N transaction attribute types, attribute value sets in the position order based on the transaction attribute values corresponding to a same transaction attribute type in the transaction data packet sequence, to obtain N attribute value sets.

Specifically, the four positionally sorted transaction shown in FIG. 4 are used as an example. An attribute value set corresponding to the transaction ID is {0x12, 0x91, 0x65, 0x17}, an attribute value set corresponding to the chain ID is {chain1, chain1, chain1, chain1}, an attribute value set corresponding to the contract method is {set, set, get, set}, and an attribute value set corresponding to the contract name is {c1, c1, c1, c2}.

Operation S104: Respectively perform incremental encoding on the N attribute value sets, to obtain N attribute value incremental encodings.

Specifically, incremental encoding is a data compression technique, in which only a changed part in a data sequence is stored, rather than storing a complete data point each time. In a blockchain transaction, incremental encoding may be configured for reducing redundancy of storing same or similar transaction data. For example, if consecutive transactions come from a same transmitter, when these transactions are stored, an address of the transmitter may be stored only once, and a tag or a reference only needs to be stored in a subsequent transaction, to indicate that the field is the same as that in a previous transaction.

By performing intelligent sorting and incremental encoding on the transaction data packets as described herein, demands for storage resources and storage costs can be reduced. Moreover, because a volume of the transaction data packet is reduced after compression, data transmission efficiency is enhanced, and a network load is reduced, which facilitates data synchronization and propagation in the blockchain system. In addition, a small data volume also means that during data query and processing, response time of the blockchain system is short, which enhances performance of the entire blockchain system.

Specifically, it is assumed that the N attribute value sets include an attribute value set Kₙ, where n is a positive integer less than or equal to N. A feasible implementation process of respectively performing incremental encoding on the N attribute value sets, to obtain N attribute value incremental encodings may be: respectively writing the 1^{st} transaction attribute value in the attribute value set Kₙ into an incremental encoding set and a transaction attribute calibration field corresponding to the attribute value set Kₙ; sequentially traversing the attribute value set Kₙ, to obtain an i^{th} transaction attribute value, i being a positive integer greater than or equal to 2 and less than or equal to M; and sequentially adding the i^{th} transaction attribute value to the incremental encoding set if the i^{th} transaction attribute value is different from a transaction attribute value included in the transaction attribute calibration field, and replacing the transaction attribute value included in the transaction attribute calibration field with the i^{th} transaction attribute value; or sequentially adding a special encoding character to the incremental encoding set if the i^{th} transaction attribute value is identical to the transaction attribute value included in the transaction attribute calibration field until it is determined that traversal of the attribute value set Kₙ is completed, and determining, based on the incremental encoding set, an attribute value incremental encoding corresponding to the attribute value set Kₙ. For example, the attribute value set Kₙ is the attribute value set K₃={set, set, get, set} corresponding to the contract method in operation S103. The blockchain node may first respectively write the 1^{st} transaction attribute value into an incremental encoding set Z and a transaction attribute calibration field word, that is, Z={set} and word=set. Then, the blockchain node traverses the attribute value set K₃ corresponding to the contract method, to obtain the 2^{nd} transaction attribute value (which is set). Because the 2^{nd} transaction attribute value is identical to a transaction attribute value included in the transaction attribute calibration field word, in this case, the blockchain node only needs to sequentially add a special encoding character (which is assumed to be *) to the incremental encoding set Z. In this case, the incremental encoding set Z={set, *}, and the transaction attribute calibration field word=set. Then, the blockchain node further obtains the 3^{rd} transaction attribute value (which is get). Because the 3^{rd} transaction attribute value is different from the transaction attribute value included in the transaction attribute calibration field word, in this case, the blockchain node respectively writes the 3^{rd} transaction attribute value into the incremental encoding set Z and the transaction attribute calibration field word. In this case, the incremental encoding set Z={set, *, get}, and the transaction attribute calibration field word=get. The rest can be deduced by analogy until the last transaction attribute value in the attribute value set K₃ is traversed, and an incremental encoding set Z={set, *, get, set} may be obtained. Therefore, an attribute value incremental encoding corresponding to the attribute value set K₃ are {set, *, get, set}. By using the special encoding character to represent identical transaction attribute values that occur in consecutive positions for the second time or more, without the need for storing complete transaction attribute values is eliminated. This helps reduce redundancy in the blockchain and improves performance of the blockchain system.

Operation S105: Perform block encapsulation on the N attribute value incremental encodings, to obtain a pending block, the pending block being configured to be added to a blockchain when consensus is reached.

Specifically, the blockchain node may add the obtained N attribute value incremental encodings to a block, to obtain the pending block, and then broadcast the pending block to other blockchain nodes in the blockchain network, to complete consensus on the pending block. When determining that consensus is reached on the pending block, the blockchain node may add the pending block to a blockchain ledger for storage.

According to the method provided in the embodiments of this application, an incremental encoding mechanism is introduced. Continuously occurring transaction attribute values corresponding to a same transaction attribute type only need to be represented by using a special encoding symbol, and complete transaction attribute values do not need to be repeatedly stored. This avoids unnecessary space waste. In addition, as described herein, the transaction data packets may be re-sorted based on the type priorities respectively corresponding to the transaction attribute types and the transaction attribute values. Such a sorting mechanism ensures that a transaction data packet with a small transaction attribute value change is prioritized in the incremental encoding phase. Therefore, high data redundancy elimination efficiency can be achieved in the incremental encoding phase. As a result, storage space required for a block is reduced, and performance of the blockchain system is enhanced.

Further, FIG. 5 is a schematic flowchart of a blockchain-based priority determination method according to an embodiment of this application. The method may be performed by a blockchain node (which is, for example, any blockchain node in the blockchain network in the embodiment corresponding to FIG. 1, such as the blockchain node 10a). The method may be configured for determining the type priorities respectively corresponding to the N transaction attribute types in the foregoing embodiment corresponding to FIG. 3. A description is made below by using an example in which the method is performed by a blockchain node. The blockchain-based priority determination method may at least include operation S201 to operation S203.

Operation S201: Obtain a type sliding window corresponding to a transaction attribute type Tⱼ in N transaction attribute types, j being a positive integer less than or equal to N, and the type sliding window including L historical transaction attribute values corresponding to the transaction attribute type Tⱼ.

Specifically, the transaction attribute type Tⱼ belongs to the N transaction attribute types in the foregoing embodiment corresponding to FIG. 3, where j is a positive integer less than or equal to N. The type sliding window corresponding to the transaction attribute type Tⱼ is configured for continuously detecting and analyzing a transaction attribute value corresponding to the transaction attribute type Tⱼ that is included in a recently chained transaction. The type sliding window “slides” with addition of a transaction attribute value corresponding to the transaction attribute type Tⱼ that is included in a new transaction. To be specific, the transaction attribute value corresponding to the transaction attribute type Tⱼ that is included in the new transaction is added to one end of the type sliding window, and a transaction attribute value corresponding to the transaction attribute type Tⱼ that is included in an old transaction is removed from the other end of the type sliding window.

Operation S202: Determine, based on transaction attribute values of the transaction attribute type Tⱼ that are included in M transaction data packets and the type sliding window, a latest attribute value distance standard deviation corresponding to the transaction attribute type Tⱼ.

Specifically, the M transaction data packets may be the M transaction data packets in the foregoing embodiment corresponding to FIG. 3. The latest attribute value distance standard deviation is an attribute value distance standard deviation determined based on the transaction attribute values of the transaction attribute type Tⱼ that are included in the M transaction data packets and the historical transaction attribute values corresponding to the transaction attribute type Tⱼ that are included in the type sliding window. The attribute value distance standard deviation is configured for reflecting a change degree of a set of transaction attribute values. A larger attribute distance standard deviation indicates a larger change degree of the set of transaction attribute values, that is, a smaller quantity of repeatedly occurring transaction attribute values. The attribute value distance refers to a distance between two transaction attribute values, and is specifically defined as that: when the two transaction attribute values are identical, the attribute value distance between the two transaction attribute values is 0, and when two transaction attribute values are different, the attribute value distance between the two transaction attribute values is 1.

Specifically, a feasible implementation process of determining, based on transaction attribute values of the transaction attribute type Tⱼ that are included in M transaction data packets and the type sliding window, a latest attribute value distance standard deviation corresponding to the transaction attribute type Tⱼ may be: sequentially placing the transaction attribute values of the transaction attribute type Tⱼ that are included in the M transaction data packets before the type sliding window; performing forward sliding on the type sliding window, to obtain a type sliding window after sliding, the type sliding window obtained after sliding including L latest transaction attribute values, and the L latest transaction attribute values including the transaction attribute values of the transaction attribute type Tⱼ that are included in the M transaction data packets; and determining, based on the L latest transaction attribute values, the latest attribute value distance standard deviation corresponding to the transaction attribute type Tⱼ.

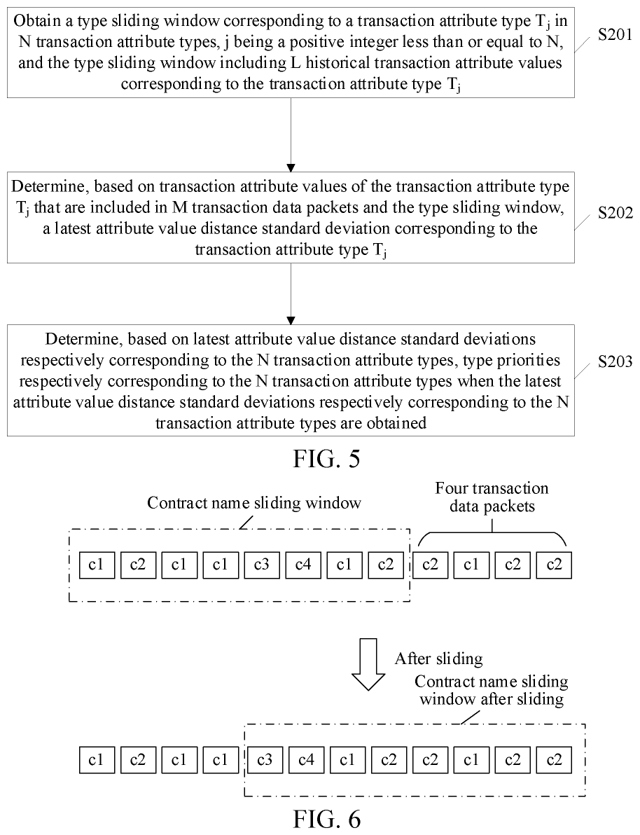

To facilitate understanding of a sliding process of the type sliding window, FIG. 6 is a schematic diagram of sliding of a type sliding window according to an embodiment of this application. As shown in FIG. 6, it is assumed that a transaction attribute type Tⱼ is a contract name, and a type sliding window corresponding to the transaction attribute type is a contract name sliding window. After obtaining contract names (which are sequentially c2, c1, c2, and c2) included in four transaction data packets, a blockchain node may obtain a contract name sliding window. In this case, the contract name sliding window may include eight historical contract names, which are sequentially c1, c2, c1, c1, c3, c4, c1, and c2. Then, the blockchain node may perform a sliding operation on the contract name sliding window, to obtain a contract name sliding window after sliding. FIG. 6 shows that the contract name sliding window obtained after sliding includes the contract names included in the four transaction data packets, and four historical contract names originally located at the end of the contract name sliding window are removed. Therefore, the contract name sliding window obtained after sliding includes eight latest contract names, which are sequentially c3, c4, c1, c2, c2, c1, c2, and c2.

Specifically, a feasible implementation process of determining, based on the L latest transaction attribute values, the latest attribute value distance standard deviation corresponding to the transaction attribute type Tⱼ may be: generating an attribute value mapping map based on the L latest transaction attribute values; and calculating, based on the quantity L and occurrence quantities respectively corresponding to P mapped attribute values, the latest attribute value distance standard deviation corresponding to the transaction attribute type Tⱼ.

The attribute value mapping map includes the P mapped attribute values and the occurrence quantities respectively corresponding to the P mapped attribute values. A single occurrence quantity refers to a quantity of latest transaction attribute values that are in the L latest transaction attribute values and that are identical to a single mapped attribute value. The mapped attribute value refers to a transaction attribute value that has occurred in the L latest transaction attribute values, and a plurality of identical transaction attribute values correspond to a same mapped attribute value. A feasible implementation process of generating an attribute value mapping map based on the L latest transaction attribute values may be: creating an initial attribute value mapping map; traversing the L latest transaction attribute values, to obtain a q^{th} latest transaction attribute value, q being a positive integer less than or equal to L; performing, if the initial attribute value mapping map includes a mapped attribute value identical to the q^{th} latest transaction attribute value, accumulation on an occurrence quantity corresponding to the mapped attribute value that is identical to the q^{th} latest transaction attribute value; or using the q^{th} latest transaction attribute value as a new mapped attribute value if the initial attribute value mapping map does not include a mapped attribute value identical to the q^{th} latest transaction attribute value, determining an initial quantity as an occurrence quantity corresponding to the new mapped attribute value, and adding the new mapped attribute value and the occurrence quantity corresponding to the new mapped attribute value to the initial attribute value mapping map; and determining an initial attribute value mapping map obtained after traversal of the L latest transaction attribute values is completed as the attribute value mapping map. For example, an attribute value mapping map generated based on the eight latest contract names (c3, c4, c1, c2, c2, c1, c2, and c2) that are included in the foregoing contract name sliding window obtained after sliding is contract name: Map (c1: 2, c2: 4, c3: 1, c4: 1). c1: 2 represents that c2 occurs twice in the eight latest contract names.

A feasible implementation process of calculating, based on the quantity L and occurrence quantities respectively corresponding to P mapped attribute values, a latest attribute value distance standard deviation corresponding to the transaction attribute type Tⱼ may be: traversing the occurrence quantities respectively corresponding to the P mapped attribute values, to obtain an s^{th} occurrence quantity, s being a positive integer less than or equal to P; and determining a difference between the quantity L and the s^{th} occurrence quantity as an s^{th} unit attribute distance, determining a product of the s^{th} unit attribute distance and the s^{th} occurrence quantity as an s^{th} attribute distance until traversal of the occurrence quantities respectively corresponding to the P mapped attribute values is completed, and performing division on a sum of P attribute distances and a square value of the quantity L, to obtain the latest attribute value distance standard deviation corresponding to the transaction attribute type Tⱼ. The foregoing calculation process may be expressed as formula (1):

$$Dis = \frac{{\sum }_{s = 1}^{P} {P}_{s} \cdot ( L - {P}_{s} )}{{L}^{2}} \qquad formula ( 1 )$$

where Dis denotes the latest attribute value distance standard deviation, Pₛ denotes the occurrence quantity corresponding to the s^{th} mapped attribute value in the P mapped attribute values, and L denotes a total length of the attribute value mapping map, namely, a quantity of latest transaction attribute values required for creation of the attribute value mapping map. P denotes a quantity of mapped attribute values.

A longer type sliding window (that is, a larger quantity of transaction attribute values that can be included) indicates a more stable latest attribute value distance standard deviation corresponding to the transaction attribute type Tⱼ that is calculated based on the type sliding window and the transaction attribute values of the transaction attribute type Tⱼ that are included in the M transaction data packets. However, correspondingly, more computational resources are required for directly calculating the latest attribute value distance standard deviation corresponding to the transaction attribute type Tⱼ based on the L latest transaction attribute values. In this case, the blockchain node may choose to update the calculated attribute value distance standard deviation based on a transaction attribute value newly added to the type sliding window and a transaction attribute value to be removed from the type sliding window, to obtain the latest attribute value distance standard deviation.

Therefore, another feasible implementation process of determining, based on transaction attribute values of the transaction attribute type Tⱼ that are included in M transaction data packets and the type sliding window, a latest attribute value distance standard deviation corresponding to the transaction attribute type Tⱼ may be: obtaining a historical attribute value distance standard deviation corresponding to the transaction attribute type Tⱼ, the historical attribute value distance standard deviation being determined based on the transaction attribute values included in the type sliding window; sequentially placing the transaction attribute values of the transaction attribute type Tⱼ that are included in the M transaction data packets before the type sliding window; performing t^{th} forward unit sliding on a type sliding window obtained after (t−1)^{th} unit sliding, to obtain a type sliding window after t^{th} unit sliding; determining a transaction attribute value located at the end of the type sliding window obtained after (t−1)^{th} unit sliding as a t^{th} sliding-removed transaction attribute value, and determining a transaction attribute value located at the head of the type sliding window obtained after t^{th} unit sliding as a t^{th} sliding-added transaction attribute value, the t^{th} sliding-added transaction attribute value belonging to the transaction attribute values of the transaction attribute type Tⱼ that are included in the M transaction data packets; updating a (t−1)^{th} updated attribute value distance standard deviation based on the t^{th} sliding-added transaction attribute value and the t^{th} sliding-removed transaction attribute value, to obtain a t^{th} updated attribute value distance standard deviation, the (t−1)^{th} updated attribute value distance standard deviation being the historical attribute value distance standard deviation when t is 1; and determining an M^{th} updated attribute value distance standard deviation as the latest attribute value distance standard deviation corresponding to the transaction attribute type Tⱼ when t is equal to M. That is, if the blockchain node has obtained the historical attribute value distance standard deviation corresponding to the transaction attribute value included in the type sliding window, the blockchain node may directly update the historical attribute value distance standard deviation, and does not need to directly calculate the latest attribute value distance standard deviation again.

A feasible implementation process of updating a (t−1)^{th} updated attribute value distance standard deviation based on the t^{th} sliding-added transaction attribute value and the t^{th} sliding-removed transaction attribute value, to obtain a t^{th} updated attribute value distance standard deviation may be: obtaining an added attribute quantity of transaction attribute values that are in the type sliding window obtained after (t−1)^{th} unit sliding and that are identical to the t^{th} sliding-added transaction attribute value, and a removed attribute quantity of transaction attribute values that are in the type sliding window obtained after (t−1)^{th} unit sliding and that are identical to the t^{th} sliding-removed transaction attribute value; performing subtraction on a difference between the quantity L and the added attribute quantity and a difference between the quantity L and the removed attribute quantity, to obtain a changed attribute distance; and adding a quotient of the changed attribute distance and the square value of the quantity L to the (t−1)^{th} updated attribute value distance standard deviation, to obtain the t^{th} updated attribute value distance standard deviation. The foregoing update process may be expressed as formula (2):

$${Dis}_{t} = {Dis}_{t - 1} + \frac{( L - {P}_{t} ) - ( L - {P}_{t - 1} )}{{L}^{2}} \qquad formula ( 2 )$$

where Disₜ denotes the t^{th} updated attribute value distance standard deviation, Disₜ₋₁ denotes the (t−1)^{th} updated attribute value distance standard deviation, Pₜ denotes the added attribute quantity, Pₜ₋₁ denotes the removed attribute quantity, and L denotes a window length of the type sliding window, namely, a quantity of transaction attribute values that can be included in the type sliding window.

Operation S203: Determine, based on latest attribute value distance standard deviations respectively corresponding to the N transaction attribute types, type priorities respectively corresponding to the N transaction attribute types when the latest attribute value distance standard deviations respectively corresponding to the N transaction attribute types are obtained.

Specifically, a smaller latest attribute value distance standard deviation corresponding to the transaction attribute type Tⱼ indicates a smaller change degree of the transaction attribute values corresponding to the transaction attribute type Tⱼ that are included in the plurality of transactions, namely, a higher likelihood of duplicate transaction attribute values. Therefore, the type priority corresponding to the transaction attribute type Tⱼ is higher. For example, when a latest attribute value distance standard deviation corresponding to a transaction attribute type T₁<a latest attribute value distance standard deviation corresponding to a transaction attribute type T₃<a latest attribute value distance standard deviation corresponding to a transaction attribute type T₂, the blockchain node may determine that the transaction attribute type T₁ corresponds to a type priority of 1, the transaction attribute type T₃ corresponds to a type priority of 2, and the transaction attribute type T₂ corresponds to a type priority of 3. That is, the type priority corresponding to the transaction attribute type T₁>the type priority corresponding to the transaction attribute type T₃>the type priority corresponding to the transaction attribute type T₂. The type priority is determined based on the latest attribute value distance standard deviation, which helps improve a type priority of a transaction attribute type with a small change degree, and lower a type priority of a transaction attribute type with a large change degree. This facilitates incremental encoding for a transaction data packet.

According to the method provided in the embodiments of this application, dynamic standard deviations of the transaction attribute types in transaction data may be calculated (that is, a latest attribute value distance standard deviation is calculated each time a block is generated), and the type priorities corresponding to the transaction attribute types are re-determined based on such a statistical feature. In this way, when position sorting is performed on the transaction data packets subsequently, a transaction with a small transaction attribute value change may be prioritized, to achieve high data redundancy elimination efficiency in the subsequent incremental encoding phase. Moreover, continuity of the transaction attributes is analyzed (a dynamic standard deviation is calculated) by using a sliding window technique. In this way, the system can monitor and evaluate a change trend of the transaction attribute value in real time, and can adapt to a change of a transaction mode, to ensure optimal performance of the compression mechanism in different transaction environments. Based on the sliding window technique, an attribute value distance standard deviation of pending data is calculated and updated in real time. Such a dynamic data processing method enables the blockchain system to adaptively adjust a data processing policy, to prioritize a transaction attribute value with a small change for processing and sorting. This achieves efficient compression in the incremental encoding phase. Such adaptability enables this application to handle different transaction modes and data changes, which ensures compression efficiency and enhances adaptability of the blockchain system to future data modes.

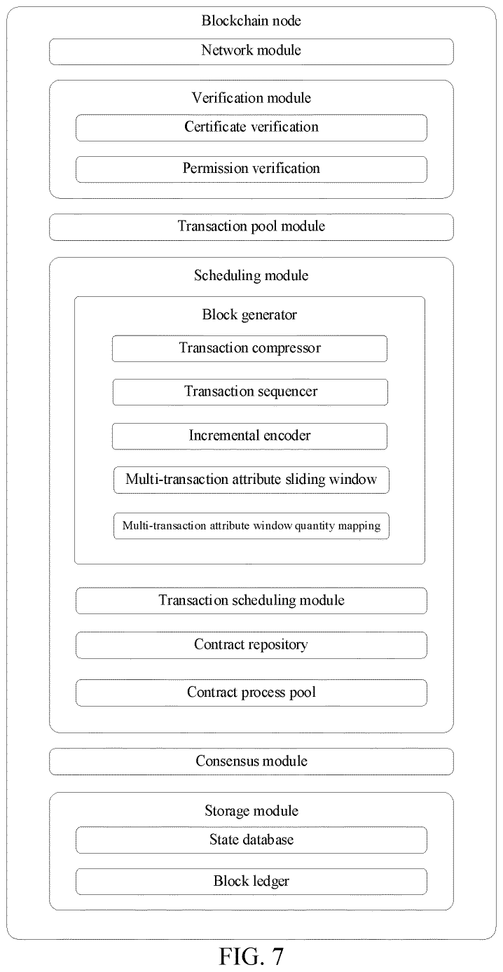

Further, the methods in the embodiments corresponding to FIG. 3 and FIG. 5 may be implemented by setting different system architectures based on an actual situation. For example, FIG. 7 is a diagram of a system architecture of a transaction incremental encoding block compression solution based on a sliding window and a dynamic standard deviation according to an embodiment of this application. As shown in FIG. 7, a blockchain node may include a network module, a verification module, a transaction pool module, a scheduling module, a consensus module, and a storage module. The following specifically describes an internal implementation of the blockchain node and interaction between the modules. Detailed descriptions are provided below.

The network module shown in FIG. 7 is responsible for processing all network communication between a node and other nodes, including transmission, receiving, and forwarding of data. The network module is a bridge through which the node interacts with the outside, and ensures that information can be securely and efficiently transmitted in a blockchain network. The network module processes all operations at a network layer, such as connection management, data transmission protocol implementation, node discovery, and data synchronization.

The verification module shown in FIG. 7 is primarily responsible for ensuring validity and correctness of transactions and blocks. Generally, the verification module includes two submodules: certificate verification and permission verification. Certificate verification is responsible for verifying an identity certificate of a creator of a transaction or a block, to ensure validity and a confidence level of the transaction or the block. Permission verification is responsible for checking whether an entity initiating a transaction data packet has a permission to execute the transaction data packet and whether a transaction satisfies a rule and a policy of a blockchain network. For example, some transactions may only be allowed to be executed by a particular user or character.

The transaction pool module shown in FIG. 7 is a temporary storage area, and is configured for storing transactions that have been received by a blockchain nodes but have not been packaged into a block. The transaction pool allows the node to sort and select transactions, to determine which transactions are to be included in a next block.

The scheduling module shown in FIG. 7 is responsible for coordinating various activities of the blockchain node, including receiving and processing of a transaction data packet, and block generation. The scheduling module includes the following submodules: a block generator, a transaction scheduling module, a contract repository, and a contract process pool. The block generator is responsible for generating a new block. The block generator selects appropriate transactions from the transaction pool, and assembles the t transactions into a block according to specific rules. The transaction scheduling module is responsible for managing transactions in the transaction pool, and determining which transactions are prioritized or included in a new block. The contract repository is configured for storing all smart contract code deployed on the blockchain and related metadata. The contract process pool is responsible for managing an execution environment of a smart contract, and providing resource isolation and execution efficiency.

The block generator shown in FIG. 7 further includes the following submodules: a transaction compressor, a transaction sequencer, an incremental encoder, a multi-transaction attribute sliding window, and multi-transaction attribute window quantity mapping. The transaction compressor is responsible for compressing transaction data, to reduce a size of a block. The transaction sequencer is configured to determine order of transaction data packets in the block. The incremental encoder encodes the transaction data through an incremental encoding technique, to further compress the data. The multi-transaction attribute sliding window is configured for implementing a sliding window technique to detect continuity of transaction attributes. Multi-transaction attribute window quantity mapping is configured for maintaining a mapping relationship among transaction attribute types in a sliding window, to support dynamic standard deviation calculation.

The consensus module shown in FIG. 7 implements a consensus algorithm in the blockchain network, and is a key to blockchain security and consistency. The consensus module ensures that all nodes reach consensus on a state of the network and verifies validity of a new block.

The storage module shown in FIG. 7 is responsible for maintaining and managing all data storage in the blockchain, including a current state and a historical record. The storage module typically includes two submodules: a state database and a block ledger. The state database is configured for storing a current blockchain state, such as an account balance or a smart contract state. The block ledger is configured for storing all blocks and transactions that have been confirmed by the network, to form a historical record of the blockchain.

The modules shown in FIG. 7 may be deployed in a blockchain node, and functions provided by the modules may also be implemented by the blockchain node.

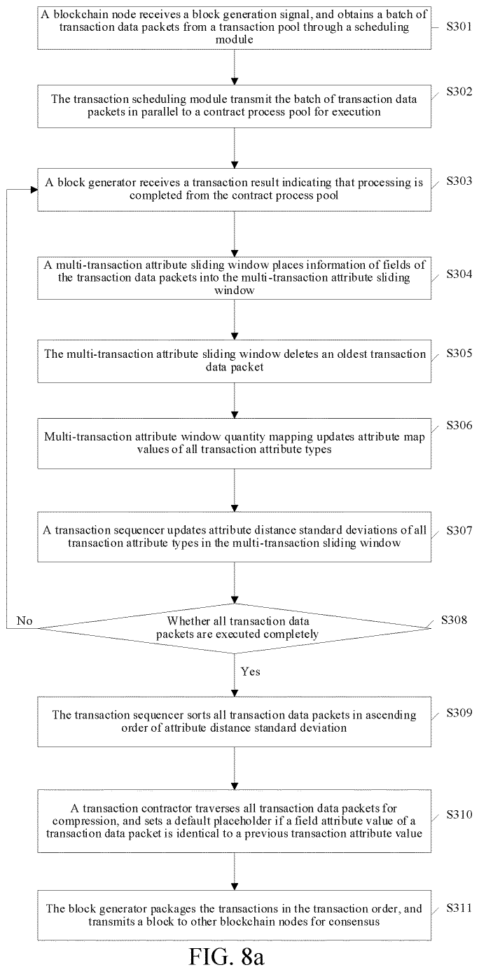

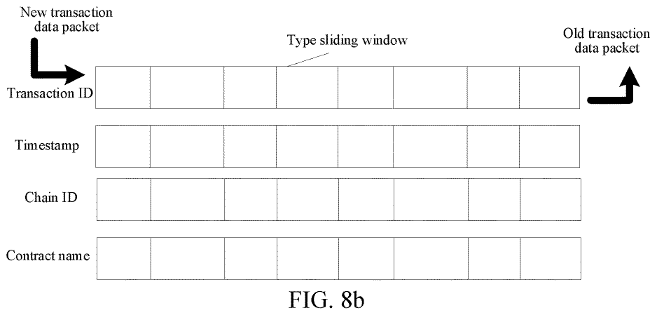

Through the coordinated operation of the modules in the system architecture of the transaction incremental encoding block compression solution based on a sliding window and a dynamic standard deviation provided in the embodiments of this application work together, the blockchain node can efficiently and stably implement a full life cycle process of the transaction incremental encoding block compression solution based on a sliding window and a dynamic standard deviation, including a transaction sorting process based on a sliding window and a dynamic standard deviation (a process in which the blockchain node calculates a dynamic standard deviation of a transaction attribute type based on information about a latest sliding window when creating a new block, determines a priority of the transaction attribute type based on the dynamic standard deviation, and sorts transactions), and a block compression process based on transaction incremental encoding (a process in which the blockchain node performs incremental encoding on attributes of transaction data packets in the sorted transactions, to compress redundant consecutive fields). As mentioned, FIG. 7 and the associated description describes a transaction sorting process based on a sliding window and a dynamic standard deviation that is implemented by using the method provided in the foregoing embodiments and the system architecture of the transaction incremental encoding block compression solution based on a sliding window and a dynamic standard deviation. FIG. 8a further depicts such aspects, which is a schematic diagram of a transaction sorting process based on a sliding window and a dynamic standard deviation according to an embodiment of this application. As shown in FIG. 8a, the entire transaction sorting process may include operation S301 to operation S311:

Operation S301: A blockchain node receives a block generation signal, and obtains a batch of transaction data packets from a transaction pool through a scheduling module.

Specifically, a quantity of the batch of transaction data packets may be M, where M is a positive integer. Therefore, the batch of transaction data packets is actually the M transaction data packets in the embodiment corresponding to FIG. 3.

Operation S302: The transaction scheduling module transmit the batch of transaction data packets in parallel to a contract process pool for execution.

Operation S303: A block generator receives a transaction result indicating that processing is completed from the contract process pool.

Operation S304: A multi-transaction attribute sliding window places information of fields of the transaction data packets into the multi-transaction attribute sliding window.

Specifically, the transaction data packet may include a plurality of fields, and a single field is configured for storing a transaction attribute value corresponding to a single transaction attribute type. Therefore, the information of the field of the transaction data packets actually refers to the transaction attribute values of the transaction attribute types that are included in the transaction data packets.

Specifically, the multi-transaction attribute sliding window may include type sliding windows corresponding to the transaction attribute types. The information of the fields of the transaction data packets being placed into the multi-transaction attribute sliding window includes that transaction attribute values corresponding to a same transaction attribute type are added to a type sliding window corresponding to the transaction attribute type. For example, as shown in FIG. 8b, transaction attribute types include a transaction ID, a timestamp, a chain ID, and a contract name. A single transaction attribute type corresponds to a single type sliding window, a corresponding transaction attribute value in each new transaction data packet is added to a corresponding type sliding window, and an old transaction data packet in the type sliding window is deleted. The new transaction data packet may refer to a pending transaction data packet, and the old transaction data packet may refer to a packaged transaction data packet.

Operation S305: The multi-transaction attribute sliding window deletes an oldest transaction data packet.

Specifically, that the oldest transaction data packet is deleted actually means that a corresponding historical transaction attribute value is deleted. A deletion quantity is determined based on a quantity of added transaction attribute values, and the deletion quantity needs to be consistent with the quantity of added transaction attribute values.

Operation S306: Multi-transaction attribute window quantity mapping updates attribute map values of all transaction attribute types.

Specifically, the attribute map values corresponding to the transaction attribute type being updated includes that an attribute value mapping map corresponding to the transaction attribute types is determined. Operations S202 may be used for a specific implementation of the foregoing embodiment corresponding to FIG. 5. Details are not described herein again.

Operation S307: A transaction sequencer updates attribute distance standard deviations of all transaction attribute types in the multi-transaction sliding window.

Specifically, the transaction sequencer updating the attribute distance standard deviations of all transaction attribute types in the multi-transaction sliding window includes that a latest attribute value distance standard deviation corresponding to the transaction attribute type is determined based on the type sliding window corresponding to each transaction attribute type. The feasible implementation process of operation S202 may be used as a specific determining process for the foregoing embodiment corresponding to FIG. 5. Details are not described herein again.

Operation S308: Determine whether all transaction data packets are executed completely; and if all transaction data packets are executed completely, perform operation S309; or if all transaction data packets are not executed completely, return to perform operation S303.

Operation S309: The transaction sequencer sorts all transaction data packets in ascending order of attribute distance standard deviation.

Specifically, operation S102 may be used for a sorting process in the foregoing embodiment corresponding to FIG. 3. Details are not described herein again.

Operation S310: A transaction contractor traverses all transaction data packets for compression, and sets a default placeholder if a field attribute value of a transaction data packet is identical to a previous transaction attribute value.

Specifically, that the transaction data packets are compressed actually means that incremental encoding is performed on the transaction data packets. Operation S103 and operation S104 may be used for a specific implementation of the foregoing embodiment corresponding to FIG. 3. Details are not described herein again.

Operation S311: The block generator packages the transactions in the transaction order, and transmits a block to other blockchain nodes for consensus.

Specifically, operation S105 may be used for an implementation of operation S311 in the foregoing embodiment corresponding to FIG. 3. Details are not described herein again.

According to the method provided in the embodiments of this application, an adaptive dynamic standard deviation sorting and storage optimization mechanism of multi-attribute transaction data is provided. Dynamic standard deviations of attributes in a transaction data packet are calculated, and transactions are resorted based on this statistical feature. Such a sorting mechanism prioritizes a transaction with a small attribute value change, to achieve high data redundancy elimination efficiency in the subsequent incremental encoding phase. By using this adaptive sorting method, storage demands can be significantly reduced and data integrity and accessibility can be maintained. This mechanism is not only applicable to a current transaction data packet, but also can be extended to a future data mode, and is very forward-looking and adaptable.

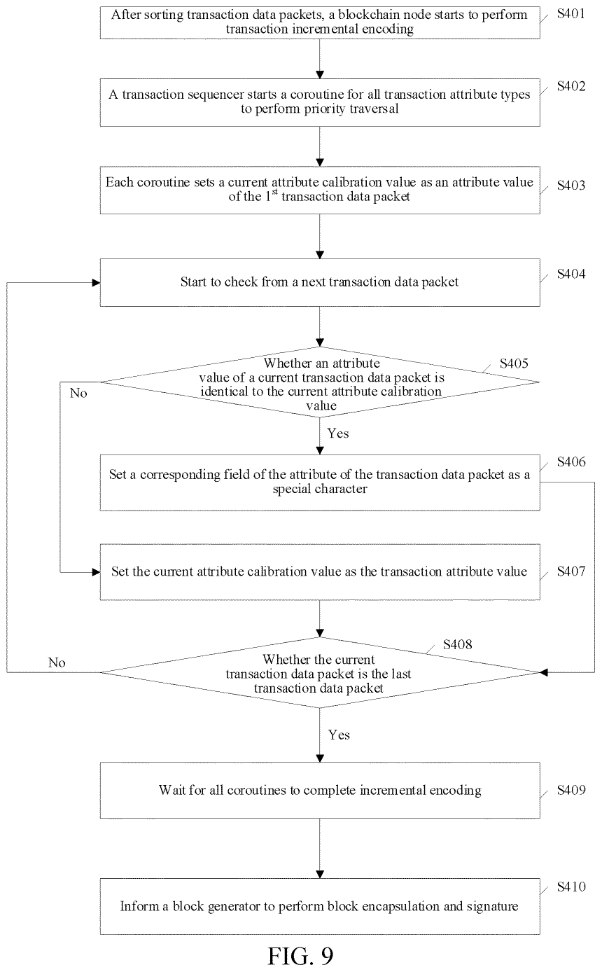

Further, to facilitate understanding of the block compression process based on transaction incremental encoding that is implemented by using the method provided in the foregoing embodiments and the system architecture of the transaction incremental encoding block compression solution based on a sliding window and a dynamic standard deviation shown in FIG. 7, FIG. 9 is a schematic diagram of a block compression process based on transaction incremental encoding according to an embodiment of this application. As shown in FIG. 9, the entire block compression process may include operation S401 to operation S410:

Operation S401: After sorting transaction data packets, a blockchain node starts to perform transaction incremental encoding.

Operation S402. A transaction sequencer starts a coroutine for all transaction attribute types to perform priority traversal.

Specifically, the blockchain node may start a coroutine for each transaction attribute type, and the coroutine is configured for performing traversal in order of the transaction data packets to obtain transaction attribute values of a corresponding transaction attribute type that are included in each transaction data packet. In an embodiment, the coroutine may first obtain the transaction attribute values of the corresponding transaction attribute type that are included in all transaction data packets, sequentially add the transaction attribute values to a same attribute value set, and then directly obtain corresponding transaction attribute values from the attribute value set, to complete incremental encoding of the transaction attribute values of the corresponding transaction attribute type.

Operation S403: Each coroutine sets a current attribute calibration value as an attribute value of the 1^{st} transaction data packet.

Specifically, each coroutine performs operation S404 to operation S408, and do not affect each other. It is assumed that a transaction attribute type corresponding to a coroutine A is a contract name, the coroutine A may set the current attribute calibration value as a transaction attribute value corresponding to the contract name that is included in the 1^{st} transaction data packet.

Operation S404: Start to check from a next transaction data packet.

Operation S405: Determine whether an attribute value of a current transaction data packet is identical to the current attribute calibration value, and if the attribute value of the current transaction data packet is identical to the current attribute calibration value, perform operation S406, or if the attribute value of a current transaction data packet is different from the current attribute calibration value, perform operation S407.

Operation S406: Set a corresponding field of the attribute of the transaction data packet as a special character, and perform operation S408.

Specifically, the special character is typically a placeholder that requires small storage space, such as *.

Operation S407: Set the current attribute calibration value as the transaction attribute value, and perform operation S408.

Operation S408: Determine whether the current transaction data packet is the last transaction data packet, and if the current transaction data packet is the last transaction data packet, perform operation S409, or if the current transaction data packet is not the last transaction data packet, return to perform operation S404.

Operation S409: Wait for all coroutines to complete incremental encoding.

Operation S410: Inform a block generator to perform block encapsulation and signature.

According to the method provided in the embodiments of this application, a compression policy in which continuity of transaction attribute values is analyzed by using a sliding window technique, and incremental encoding is implemented based on this analysis. By dynamically updating transaction data packets in a sliding window, a system can monitor and evaluate a change trend of a transaction attribute value in real time, to effectively mark and compress consecutive duplicate transaction attribute values in an encoding process. Such a policy not only improves data compression efficiency, but also can adapt to a change in a transaction mode due to dynamic nature. This ensures optimal performance of the compression mechanism in different transaction environments.

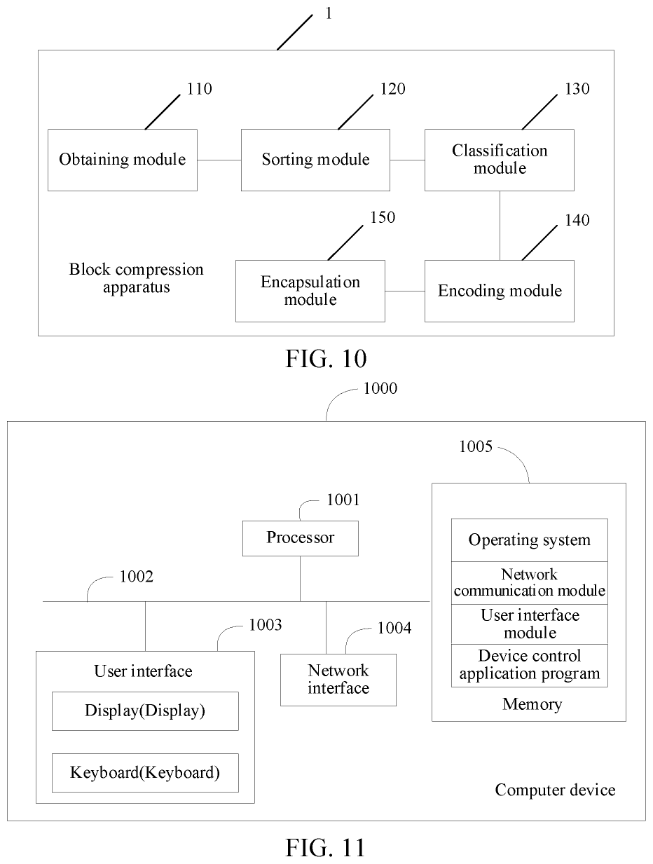

FIG. 10 is a schematic structural diagram of a block compression apparatus according to an embodiment of this application. The block compression apparatus may be a computer program (including program code) running on a computer device. For example, the block compression apparatus is application software. A block compression apparatus 1 may be configured to perform corresponding operations in the block compression method provided in the embodiments of this application. As shown in FIG. 10, the block compression apparatus 1 may include: an obtaining module 110, a sorting module 120, a classification module 130, an encoding module 140, and an encapsulation module 150.

The obtaining module 110 is configured to obtain M transaction data packets, each of the transaction data packets including transaction attribute values respectively corresponding to N transaction attribute types, and M and N being both positive integers.

The sorting module 120 is configured to determine position order of the M transaction data packets based on type priorities respectively corresponding to the N transaction attribute types and the transaction attribute values, to obtain a transaction data packet sequence.

The classification module 130 is configured to respectively generate, for the N transaction attribute types, attribute value sets in the position order based on the transaction attribute values corresponding to a same transaction attribute type in the transaction data packet sequence, to obtain N attribute value sets.

The encoding module 140 is configured to respectively perform incremental encoding on the N attribute value sets, to obtain N attribute value incremental encodings.

The encapsulation module 150 is configured to perform block encapsulation on the N attribute value incremental encodings, to obtain a pending block, the pending block being configured to be added to a blockchain when consensus is reached.

In a possible implementation, when configured to determine position order of the M transaction data packets based on type priorities respectively corresponding to the N transaction attribute types and the transaction attribute values, to obtain a transaction data packet sequence, the sorting module 120 is specifically configured to:
traverse the N transaction attribute types based on the type priorities respectively corresponding to the N transaction attribute types, to obtain a k^{th} transaction attribute type, a type priority corresponding to the k^{th} transaction attribute type being lower than a type priority corresponding to an obtained (k−1)^{th} transaction attribute type;
perform, based on M transaction attribute values corresponding to the k^{th} transaction attribute type, k^{th} position sorting on M candidate transaction data packets obtained after (k−1)^{th} position sorting, to obtain M candidate transaction data packets after k^{th} position sorting, the M candidate transaction data packets obtained after (k−1)^{th} position sorting being the M transaction data packets when k is 1; and
further obtain a (k+1)^{th} transaction attribute type in response to the M transaction attribute values corresponding to the k^{th} transaction attribute type including identical transaction attribute values, and perform, based on M transaction attribute values corresponding to the (k+1)^{th} transaction attribute type, (k+1)^{th} position sorting on the M candidate transaction data packets obtained after k^{th} position sorting; or
stop traversal of the N transaction attribute types in response to the M transaction attribute values corresponding to the k^{th} transaction attribute type not including transaction attribute values that are identical and are consecutive in position, and determine the M candidate transaction data packets obtained after k^{th} position sorting as the transaction data packet sequence.

In a possible implementation, when configured to perform, based on M transaction attribute values corresponding to the k^{th} transaction attribute type, k^{th} position sorting on M candidate transaction data packets obtained after (k−1)^{th} position sorting, to obtain M candidate transaction data packets after k^{th} position sorting, the sorting module 120 is specifically configured to:
perform attribute value sorting on the M transaction attribute values corresponding to the k^{th} transaction attribute type, to obtain M sorted transaction attribute values;
determine candidate transaction data packets in the M candidate transaction data packets obtained after (k−1)^{th} position sorting that include identical first transaction attribute values and that are consecutive in position as to-be-adjusted candidate transaction data packets, the first transaction attribute value being a transaction attribute value of the (k−1)^{th} transaction attribute type, and the to-be-adjusted candidate transaction data packet being the M transaction data packets when k is 1; and
perform position adjustment on the to-be-adjusted candidate transaction data packets in the M candidate transaction data packets based on a position relationship among second transaction attribute values included in the to-be-adjusted candidate transaction data packets in the M sorted transaction attribute values, to obtain the M candidate transaction data packets after k^{th} position sorting, the second transaction attribute value being a transaction attribute value of the k^{th} transaction attribute type.

In a possible implementation, the N attribute value sets include an attribute value set Kₙ where n is a positive integer less than or equal to N. When configured to respectively perform incremental encoding on the N attribute value sets, to obtain N attribute value incremental encodings, the encoding module 140 is specifically configured to:
respectively write the 1^{st} transaction attribute value in the attribute value set Kₙ into an incremental encoding set and a transaction attribute calibration field corresponding to the attribute value set Kₙ;
sequentially traverse the attribute value set Kₙ, to obtain an i^{th} transaction attribute value, where i being a positive integer greater than or equal to 2 and less than or equal to M; and
sequentially add the i^{th} transaction attribute value to the incremental encoding set in response to the i^{th} transaction attribute value being different from a transaction attribute value included in the transaction attribute calibration field, and replace the transaction attribute value included in the transaction attribute calibration field with the i^{th} transaction attribute value; or
sequentially add a special encoding character to the incremental encoding set in response to the i^{th} transaction attribute value being identical to the transaction attribute value included in the transaction attribute calibration field until a determination that traversal of the attribute value set Kₙ is completed, and determine, based on the incremental encoding set, an attribute value incremental encoding corresponding to the attribute value set Kₙ.

In a possible implementation, the N transaction attribute types include a transaction attribute type Tⱼ, where j is a positive integer less than or equal to N. The sorting module 120 is further configured to:
obtain a type sliding window corresponding to the transaction attribute type Tⱼ, the type sliding window including L historical transaction attribute values corresponding to the transaction attribute type Tⱼ;
determine, based on transaction attribute values of the transaction attribute type Tⱼ that are included in the M transaction data packets and the type sliding window, a latest attribute value distance standard deviation corresponding to the transaction attribute type Tⱼ; and
determine, based on latest attribute value distance standard deviations respectively corresponding to the N transaction attribute types, the type priorities respectively corresponding to the N transaction attribute types when the latest attribute value distance standard deviations respectively corresponding to the N transaction attribute types are obtained.

In a possible implementation, when configured to determine, based on transaction attribute values of the transaction attribute type Tⱼ that are included in the M transaction data packets and the type sliding window, a latest attribute value distance standard deviation corresponding to the transaction attribute type Tⱼ, the sorting module 120 is specifically configured to:
sequentially place the transaction attribute values of the transaction attribute type Tⱼ that are included in the M transaction data packets before the type sliding window;
perform forward sliding on the type sliding window, to obtain a type sliding window after sliding, the type sliding window obtained after sliding including L latest transaction attribute values, and the L latest transaction attribute values including the transaction attribute values of the transaction attribute type Tⱼ that are included in the M transaction data packets; and
determine, based on the L latest transaction attribute values, the latest attribute value distance standard deviation corresponding to the transaction attribute type Tⱼ.

In a possible implementation, when configured to determine, based on the L latest transaction attribute values, the latest attribute value distance standard deviation corresponding to the transaction attribute type Tⱼ, the sorting module 120 is specifically configured to:
generate an attribute value mapping map based on the L latest transaction attribute values, the attribute value mapping map including P mapped attribute values and occurrence quantities respectively corresponding to the P mapped attribute values, and a single occurrence quantity being a quantity of latest transaction attribute values that are in the L latest transaction attribute values and that are identical to a single mapped attribute value; and
calculate, based on the quantity L and the occurrence quantities respectively corresponding to the P mapped attribute values, the latest attribute value distance standard deviation corresponding to the transaction attribute type Tⱼ.

In a possible implementation, when configured to generate an attribute value mapping map based on the L latest transaction attribute values, the sorting module 120 is specifically configured to:
create an initial attribute value mapping map;
traverse the L latest transaction attribute values, to obtain a q^{th} latest transaction attribute value, q being a positive integer less than or equal to L;
perform, in response to the initial attribute value mapping map including a mapped attribute value identical to the q^{th} latest transaction attribute value, accumulation on an occurrence quantity corresponding to the mapped attribute value that is identical to the q^{th} latest transaction attribute value; or
use the q^{th} latest transaction attribute value as a new mapped attribute value in response to the initial attribute value mapping map not including a mapped attribute value identical to the q^{th} latest transaction attribute value, determine an initial quantity as an occurrence quantity corresponding to the new mapped attribute value, and add the new mapped attribute value and the occurrence quantity corresponding to the new mapped attribute value to the initial attribute value mapping map; and
determine an initial attribute value mapping map obtained after traversal of the L latest transaction attribute values is completed as the attribute value mapping map.

In a possible implementation, when configured to calculate, based on the quantity L and the occurrence quantities respectively corresponding to the P mapped attribute values, the latest attribute value distance standard deviation corresponding to the transaction attribute type Tⱼ, the sorting module 120 is specifically configured to:
traverse the occurrence quantities respectively corresponding to the P mapped attribute values, to obtain an s^{th} occurrence quantity, s being a positive integer less than or equal to P; and
determine a difference between the quantity L and the s^{th} occurrence quantity as an s^{th} unit attribute distance, determine a product of the s^{th} unit attribute distance and the s^{th} occurrence quantity as an s^{th} attribute distance until traversal of the occurrence quantities respectively corresponding to the P mapped attribute values is completed, and perform division on a sum of P attribute distances and a square value of the quantity L, to obtain the latest attribute value distance standard deviation corresponding to the transaction attribute type Tⱼ.

In a possible implementation, when configured to determine, based on transaction attribute values of the transaction attribute type Tⱼ that are included in the M transaction data packets and the type sliding window, a latest attribute value distance standard deviation corresponding to the transaction attribute type Tⱼ, the sorting module 120 is specifically configured to:
obtain a historical attribute value distance standard deviation corresponding to the transaction attribute type Tⱼ, the historical attribute value distance standard deviation being determined based on the transaction attribute values included in the type sliding window;
sequentially place the transaction attribute values of the transaction attribute type Tⱼ that are included in the M transaction data packets before the type sliding window;
perform t^{th} forward unit sliding on a type sliding window obtained after (t−1)^{th} unit sliding, to obtain a type sliding window after t^{th} unit sliding;
determine a transaction attribute value located at the end of the type sliding window obtained after (t−1)^{th} unit sliding as a t^{th} sliding-removed transaction attribute value, and determine a transaction attribute value located at the head of the type sliding window obtained after t^{th} unit sliding as a t^{th} sliding-added transaction attribute value, the t^{th} sliding-added transaction attribute value belonging to the transaction attribute values of the transaction attribute type Tⱼ that are included in the M transaction data packets;
update a (t−1)^{th} updated attribute value distance standard deviation based on the t^{th} sliding-added transaction attribute value and the t^{th} sliding-removed transaction attribute value, to obtain a t^{th} updated attribute value distance standard deviation, the (t−1)^{th} updated attribute value distance standard deviation being the historical attribute value distance standard deviation when t is 1; and
determine an M^{th} updated attribute value distance standard deviation as the latest attribute value distance standard deviation corresponding to the transaction attribute type Tⱼ when t is equal to M.

In a possible implementation, when configured to update a (t−1)^{th} updated attribute value distance standard deviation based on the t^{th} sliding-added transaction attribute value and the t^{th} sliding-removed transaction attribute value, to obtain a t^{th} updated attribute value distance standard deviation, the sorting module 120 is specifically configured to:
obtain an added attribute quantity of transaction attribute values that are in the type sliding window obtained after (t−1)^{th} unit sliding and that are identical to the t^{th} sliding-added transaction attribute value, and a removed attribute quantity of transaction attribute values that are in the type sliding window obtained after (t−1)^{th} unit sliding and that are identical to the t^{th} sliding-removed transaction attribute value;
perform subtraction on a difference between the quantity L and the added attribute quantity and a difference between the quantity L and the removed attribute quantity, to obtain a changed attribute distance; and
add a quotient of the changed attribute distance and the square value of the quantity L to the (t−1)^{th} updated attribute value distance standard deviation, to obtain the t^{th} updated attribute value distance standard deviation.

In the embodiments of this application, the blockchain node may obtain the M transaction data packets, each of the transaction data packets including the transaction attribute values of the N transaction attribute types; perform position sorting on the M transaction data packets based on the type priorities respectively corresponding to the N transaction attribute types and the M transaction attribute values respectively corresponding to the N transaction attribute types, to obtain the transaction data packet sequence; add the transaction attribute values of the same transaction attribute type in the transaction data packet sequence to the same attribute value set in the position order of the transaction data packet sequence, to obtain the attribute value sets respectively corresponding to the N transaction attribute types; respectively perform incremental encoding on the N attribute value sets, to obtain the N attribute value incremental encodings; and finally, perform block encapsulation on the N attribute value incremental encodings, to obtain the pending block, the pending block being configured to be added to the blockchain when consensus is reached. According to the method provided in the embodiments of this application, the transaction data packets may be first resorted based on the type priorities respectively corresponding to the transaction attribute types and the transaction attribute values. Such a sorting mechanism ensures that a transaction data packet with a small transaction attribute value change is prioritized in the incremental encoding phase. Therefore, high data redundancy elimination efficiency can be achieved in the incremental encoding phase. As a result, storage space required for a block is reduced, and performance of the blockchain system is enhanced.

FIG. 11 is a schematic structural diagram of a computer device according to an embodiment of this application. As shown in FIG. 11, the block compression apparatus 1 in the foregoing embodiment corresponding to FIG. 10 may be used in a computer device 1000. The computer device 1000 may include: a processor 1001, a network interface 1004, and a memory 1005. In addition, the computer device 1000 may further include: a user interface 1003 and at least one communication bus 1002. The communications bus 1002 is configured to implement connection and communication between the components. The user interface 1003 may include a display, a keyboard. In an embodiment, the user interface 1003 may further include a standard wired interface and a standard wireless interface. In an embodiment, the network interface 1004 may include a standard wired interface and a standard wireless interface (such as a Wi-Fi interface). The memory 1005 may be a high-speed random-access memory (RAM), or may be a non-volatile memory, such as at least one magnetic disk memory. In an embodiment, the memory 1005 may alternatively be at least one storage apparatus away from the processor 1001. As shown in FIG. 10, the memory 1005 used as a computer-readable storage medium may include an operating system, a network communication module, a user interface module, and a device control application program.

In the computer device 1000 shown in FIG. 10, the network interface 1004 may provide a network communication element. The user interface 1003 is primarily configured for providing an input interface for a user. The processor 1001 may be configured to invoke the device control application program stored in the memory 1005, to implement:
obtaining M transaction data packets, each of the transaction data packets including transaction attribute values respectively corresponding to N transaction attribute types, and M and N being both positive integers;
determining position order of the M transaction data packets based on type priorities respectively corresponding to the N transaction attribute types and the transaction attribute values, to obtain a transaction data packet sequence;
respectively generating, for the N transaction attribute types, attribute value sets in the position order based on the transaction attribute values corresponding to a same transaction attribute type in the transaction data packet sequence, to obtain N attribute value sets;
respectively performing incremental encoding on the N attribute value sets, to obtain N attribute value incremental encodings; and
performing block encapsulation on the N attribute value incremental encodings, to obtain a pending block, the pending block being configured to be added to a blockchain when consensus is reached.

The computer device 1000 described in the embodiments of this application may implement the description of the block compression method in the foregoing embodiment corresponding to any one of FIG. 3 and FIG. 5. Details are not described herein again. In addition, the description of beneficial effects of the same method are not described herein again.

Embodiments of this application further provide a non-transitory computer-readable storage medium. The computer-readable storage medium stores a computer program executed by the block compression apparatus 1 mentioned above, and the computer program includes program instructions. When executing the program instructions, the processor can implement the description of the block compression method in the foregoing embodiment corresponding to any one of FIG. 3 and FIG. 5. Therefore, details are not described herein again. In addition, the description of beneficial effects of the same method are not described herein again. For technical details that are not disclosed in the embodiments of the computer-readable storage medium of this application, refer to the description of the method embodiments of this application.

The computer-readable storage medium may be an internal storage unit in the block compression apparatus or the computer device provided in any one of the foregoing embodiments, such as a hard drive or a memory of the computer device. The computer-readable storage medium may alternatively be an external storage device of the computer device, such as a removable hard drive, a smart media card (SMC), a secure digital (SD) card, or a flash card equipped on the computer device. Further, the computer-readable storage medium may alternatively include both an internal storage unit and an external storage device of the computer device. The computer-readable storage medium is configured to store the computer program and other programs and data that are required by the computer device. The computer-readable storage medium may further be configured to temporarily store data that has been outputted or data to be outputted.

Embodiments of this application further provide a computer program product or a computer program. The computer program product or the computer program includes computer instructions, and the computer instructions are stored in a computer-readable storage medium. A processor of a computer device reads the computer instructions from the computer-readable storage medium, and executes the computer instructions, to cause the computer device to perform the method in the foregoing embodiment corresponding to any one of FIG. 3 and FIG. 4.

The terms “first”, “second”, and the like in the description, the claims, and the drawings of the embodiments of this application are intended to distinguish between different objects, rather than describing a particular sequence. In addition, the terms “include” and any variation thereof are intended to cover a non-exclusive inclusion. For example, a process, method, apparatus, product, or device including a series of steps or units is not limited to the listed steps or modules, but instead, include steps or modules not listed in some embodiments, or include other steps or units inherent in the process, method, apparatus, product, or device in some embodiments.

In the embodiments of this application, the term “module” or “unit” refers to a computer program with a preset function or a part of the computer program, and operates, together with other related parts, to implement a preset target, and may be completely or partially implemented by using software, hardware (such as a processing circuit or a memory), or a combination thereof. Similarly, a single processor (or a plurality of processors or memories) may be configured to implement one or more modules or units. In addition, each module or unit may be a part of an overall module or unit including a function of the module or unit.

A person of ordinary skill in the art may be aware that, units and algorithm steps of the examples described with reference to the embodiments disclosed herein may be implemented by using electronic hardware, computer software, or a combination thereof. To clearly describe the interchangeability between the hardware and the software, the foregoing has generally described compositions and steps of the examples based on network elements. Whether the network elements are implemented in the form of hardware or software depends on particular applications and design constraint conditions of the technical solutions. A person skilled in the art may use different methods to implement the described network elements for each particular application, but the implementation is not considered to depart from the scope of this application.

What is disclosed above is merely exemplary embodiments of this application, and certainly is not intended to limit the scope of the claims of this application. Therefore, equivalent variations made in accordance with the claims of this application fall within the scope of this application.

What is claimed is:

1. A blockchain-based block compression method, the method being performed by a blockchain node, and the method comprising:
obtaining M transaction data packets, each of the transaction data packets comprising transaction attribute values respectively corresponding to N transaction attribute types, and M and N being both positive integers;
determining a position order of the M transaction data packets based on type priorities respectively corresponding to the N transaction attribute types and the transaction attribute values, to obtain a transaction data packet sequence;
respectively generating, for the N transaction attribute types, attribute value sets in the position order based on the transaction attribute values corresponding to a same transaction attribute type in the transaction data packet sequence, to obtain N attribute value sets;
respectively performing incremental encoding on the N attribute value sets, to obtain N attribute value incremental encodings; and
performing block encapsulation on the N attribute value incremental encodings, to obtain a pending block, the pending block being configured to be added to a blockchain when consensus is reached.

2. The method according to claim 1, wherein the determining the position order of the M transaction data packets based on type priorities respectively corresponding to the N transaction attribute types and the transaction attribute values, to obtain the transaction data packet sequence comprises:
traversing the N transaction attribute types based on the type priorities respectively corresponding to the N transaction attribute types, to obtain a k^{th} transaction attribute type, a type priority corresponding to the k^{th} transaction attribute type being lower than a type priority corresponding to an obtained (k−1)^{th} transaction attribute type;
performing, based on M transaction attribute values corresponding to the k^{th} transaction attribute type, k^{th} position sorting on M candidate transaction data packets obtained after (k−1)^{th} position sorting, to obtain M candidate transaction data packets after k^{th} position sorting, the M candidate transaction data packets obtained after (k−1)^{th} position sorting being the M transaction data packets when k is 1; and
further obtaining a (k+1)^{th} transaction attribute type in response to the M transaction attribute values corresponding to the k^{th} transaction attribute type comprising identical transaction attribute values, and performing, based on M transaction attribute values corresponding to the (k+1)^{th} transaction attribute type, (k+1)^{th} position sorting on the M candidate transaction data packets obtained after k^{th} position sorting; or
stopping traversal of the N transaction attribute types in response to the M transaction attribute values corresponding to the k^{th} transaction attribute type not comprising transaction attribute values that are identical and are consecutive in position, and determining the M candidate transaction data packets obtained after k^{th} position sorting as the transaction data packet sequence.

3. The method according to claim 2, wherein the performing, based on the M transaction attribute values corresponding to the k^{th} transaction attribute type, the k^{th} position sorting on the M candidate transaction data packets obtained after the (k−1)^{th} position sorting, to obtain the M candidate transaction data packets after the k^{th} position sorting comprises:
performing attribute value sorting on the M transaction attribute values corresponding to the k^{th} transaction attribute type, to obtain M sorted transaction attribute values;
determining candidate transaction data packets in the M candidate transaction data packets obtained after (k−1)^{th} position sorting that comprise identical first transaction attribute values and that are consecutive in position as to-be-adjusted candidate transaction data packets, the first transaction attribute value being a transaction attribute value of the (k−1)^{th} transaction attribute type; and the to-be-adjusted candidate transaction data packets being the M transaction data packets when k is 1; and
performing position adjustment on the to-be-adjusted candidate transaction data packets in the M candidate transaction data packets based on a position relationship among second transaction attribute values comprised in the to-be-adjusted candidate transaction data packets in the M sorted transaction attribute values, to obtain the M candidate transaction data packets after k^{th} position sorting, the second transaction attribute value being a transaction attribute value of the k^{th} transaction attribute type.

4. The method according to claim 3, wherein the performing attribute value sorting on M transaction attribute values corresponding to the k^{th} transaction attribute type, to obtain M sorted transaction attribute values comprises:
performing statistics collection on a quantity of identical transaction attribute values in the M transaction attribute values corresponding to the k^{th} transaction attribute type; and
sorting the identical transaction attribute values in the M transaction attribute values corresponding to the k^{th} transaction attribute type in consecutive adjacent positions in descending order of the quantity of identical transaction attribute values, to obtain the M sorted transaction attribute values.

5. The method according to claim 1, wherein the N attribute value sets comprise an attribute value set Kₙ, and n is a positive integer less than or equal to N; and
the respectively performing incremental encoding on the N attribute value sets, to obtain the N attribute value incremental encodings comprises:
respectively writing the 1^{st} transaction attribute value in the attribute value set Kₙ into an incremental encoding set and a transaction attribute calibration field corresponding to the attribute value set Kₙ;
sequentially traversing the attribute value set Kₙ, to obtain an i^{th} transaction attribute value, i being a positive integer greater than or equal to 2 and less than or equal to M; and
sequentially adding the i^{th} transaction attribute value to the incremental encoding set in response to the i^{th} transaction attribute value being different from a transaction attribute value comprised in the transaction attribute calibration field, and replacing the transaction attribute value comprised in the transaction attribute calibration field with the i^{th} transaction attribute value; or
sequentially adding a special encoding character to the incremental encoding set in response to the i^{th} transaction attribute value being identical to the transaction attribute value comprised in the transaction attribute calibration field until a determination that traversal of the attribute value set Kₙ is completed, and determining, based on the incremental encoding set, an attribute value incremental encoding corresponding to the attribute value set Kₙ.

6. The method according to claim 1, wherein the N transaction attribute types comprise a transaction attribute type Tⱼ, and j is a positive integer less than or equal to N; and
the method further comprises:
obtaining a type sliding window corresponding to the transaction attribute type Tⱼ, the type sliding window comprising L historical transaction attribute values corresponding to the transaction attribute type Tⱼ;
determining, based on transaction attribute values of the transaction attribute type Tⱼ that are comprised in the M transaction data packets and the type sliding window, a latest attribute value distance standard deviation corresponding to the transaction attribute type Tⱼ; and
determining, based on latest attribute value distance standard deviations respectively corresponding to the N transaction attribute types, the type priorities respectively corresponding to the N transaction attribute types when the latest attribute value distance standard deviations respectively corresponding to the N transaction attribute types are obtained.

7. The method according to claim 6, wherein the determining, based on the transaction attribute values of the transaction attribute type Tⱼ that are comprised in the M transaction data packets and the type sliding window, the latest attribute value distance standard deviation corresponding to the transaction attribute type Tⱼ comprises:
sequentially placing the transaction attribute values of the transaction attribute type Tⱼ that are comprised in the M transaction data packets before the type sliding window;
performing forward sliding on the type sliding window, to obtain a type sliding window after sliding, the type sliding window obtained after sliding comprising L latest transaction attribute values; and the L latest transaction attribute values comprising the transaction attribute values of the transaction attribute type Tⱼ that are comprised in the M transaction data packets; and
determining, based on the L latest transaction attribute values, the latest attribute value distance standard deviation corresponding to the transaction attribute type Tⱼ.

8. The method according to claim 7, wherein the determining, based on the L latest transaction attribute values, the latest attribute value distance standard deviation corresponding to the transaction attribute type Tⱼ comprises:
generating an attribute value mapping map based on the L latest transaction attribute values, the attribute value mapping map comprising P mapped attribute values and occurrence quantities respectively corresponding to the P mapped attribute values; and a single occurrence quantity being a quantity of latest transaction attribute values that are in the L latest transaction attribute values and that are identical to a single mapped attribute value; and
calculating, based on the quantity L and the occurrence quantities respectively corresponding to the P mapped attribute values, the latest attribute value distance standard deviation corresponding to the transaction attribute type Tⱼ.

9. The method according to claim 8, wherein the generating the attribute value mapping map based on the L latest transaction attribute values comprises:
creating an initial attribute value mapping map;
traversing the L latest transaction attribute values, to obtain a q^{th} latest transaction attribute value, q being a positive integer less than or equal to L;
performing, in response to the initial attribute value mapping map comprising a mapped attribute value identical to the q^{th} latest transaction attribute value, accumulation on an occurrence quantity corresponding to the mapped attribute value that is identical to the q^{th} latest transaction attribute value;
using the q^{th} latest transaction attribute value as a new mapped attribute value in response to the initial attribute value mapping map not comprising a mapped attribute value identical to the q^{th} latest transaction attribute value, determining an initial quantity as an occurrence quantity corresponding to the new mapped attribute value, and adding the new mapped attribute value and the occurrence quantity corresponding to the new mapped attribute value to the initial attribute value mapping map; and
determining an initial attribute value mapping map obtained after traversal of the L latest transaction attribute values is completed as the attribute value mapping map.

10. The method according to claim 9, wherein calculating, based on the quantity L and the occurrence quantities respectively corresponding to the P mapped attribute values, the latest attribute value distance standard deviation corresponding to the transaction attribute type Tⱼ comprises:
traversing the occurrence quantities respectively corresponding to the P mapped attribute values, to obtain an s^{th} occurrence quantity, s being a positive integer less than or equal to P; and
determining a difference between the quantity L and the s^{th} occurrence quantity as an s^{th} unit attribute distance, determining a product of the s^{th} unit attribute distance and the s^{th} occurrence quantity as an s^{th} attribute distance until traversal of the occurrence quantities respectively corresponding to the P mapped attribute values is completed, and performing division on a sum of P attribute distances and a square value of the quantity L, to obtain the latest attribute value distance standard deviation corresponding to the transaction attribute type Tⱼ.

11. The method according to claim 6, wherein the determining, based on the transaction attribute values of the transaction attribute type Tⱼ that are comprised in the M transaction data packets and the type sliding window, the latest attribute value distance standard deviation corresponding to the transaction attribute type Tⱼ comprises:
obtaining a historical attribute value distance standard deviation corresponding to the transaction attribute type Tⱼ, the historical attribute value distance standard deviation being determined based on the transaction attribute values comprised in the type sliding window;
sequentially placing the transaction attribute values of the transaction attribute type Tⱼ that are comprised in the M transaction data packets before the type sliding window;
performing t^{th} forward unit sliding on a type sliding window obtained after (t−1)^{th} unit sliding, to obtain a type sliding window after t^{th} unit sliding;
determining a transaction attribute value located at the end of the type sliding window obtained after (t−1)^{th} unit sliding as a t^{th} sliding-removed transaction attribute value, and determining a transaction attribute value located at the head of the type sliding window obtained after t^{th} unit sliding as a t^{th} sliding-added transaction attribute value, the t^{th} sliding-added transaction attribute value belonging to the transaction attribute values of the transaction attribute type Tⱼ that are comprised in the M transaction data packets;
updating a (t−1)^{th} updated attribute value distance standard deviation based on the t^{th} sliding-added transaction attribute value and the t^{th} sliding-removed transaction attribute value, to obtain a t^{th} updated attribute value distance standard deviation, the (t−1)^{th} updated attribute value distance standard deviation being the historical attribute value distance standard deviation when tis 1; and
determining an M^{th} updated attribute value distance standard deviation as the latest attribute value distance standard deviation corresponding to the transaction attribute type Tⱼ when t is equal to M.

12. The method according to claim 11, wherein the updating the (t−1)^{th} updated attribute value distance standard deviation based on the t^{th} sliding-added transaction attribute value and the t^{th} sliding-removed transaction attribute value, to obtain the t^{th} updated attribute value distance standard deviation comprises:
obtaining an added attribute quantity of transaction attribute values that are in the type sliding window obtained after (t−1)^{th} unit sliding and that are identical to the t^{th} sliding-added transaction attribute value, and a removed attribute quantity of transaction attribute values that are in the type sliding window obtained after (t−1)^{th} unit sliding and that are identical to the t^{th} sliding-removed transaction attribute value;
performing subtraction on a difference between the quantity L and the added attribute quantity and a difference between the quantity L and the removed attribute quantity, to obtain a changed attribute distance; and
adding a quotient of the changed attribute distance and the square value of the quantity L to the (t−1)^{th} updated attribute value distance standard deviation, to obtain the t^{th} updated attribute value distance standard deviation.

13. An apparatus comprising:
a memory storing a plurality of instructions; and
a processor configured to execute the plurality of instructions, wherein upon execution of the plurality of instructions, the processor is configured to:
obtain M transaction data packets, each of the transaction data packets comprising transaction attribute values respectively corresponding to N transaction attribute types, and M and N being both positive integers;
determine a position order of the M transaction data packets based on type priorities respectively corresponding to the N transaction attribute types and the transaction attribute values, to obtain a transaction data packet sequence;
respectively generate, for the N transaction attribute types, attribute value sets in the position order based on the transaction attribute values corresponding to a same transaction attribute type in the transaction data packet sequence, to obtain N attribute value sets;
respectively perform incremental encoding on the N attribute value sets, to obtain N attribute value incremental encodings; and
perform block encapsulation on the N attribute value incremental encodings, to obtain a pending block, the pending block being configured to be added to a blockchain when consensus is reached.

14. The apparatus according to claim 13, wherein to determine the position order of the M transaction data packets based on type priorities respectively corresponding to the N transaction attribute types and the transaction attribute values, to obtain the transaction data packet sequence, the processor, upon execution of the plurality of instructions is configured to:
traverse the N transaction attribute types based on the type priorities respectively corresponding to the N transaction attribute types, to obtain a k^{th} transaction attribute type, a type priority corresponding to the k^{th} transaction attribute type being lower than a type priority corresponding to an obtained (k−1)^{th} transaction attribute type;
perform, based on M transaction attribute values corresponding to the k^{th} transaction attribute type, k^{th} position sorting on M candidate transaction data packets obtained after (k−1)^{th} position sorting, to obtain M candidate transaction data packets after k^{th} position sorting, the M candidate transaction data packets obtained after (k−1)^{th} position sorting being the M transaction data packets when k is 1; and
further obtain a (k+1)^{th} transaction attribute type in response to the M transaction attribute values corresponding to the k^{th} transaction attribute type comprising identical transaction attribute values, and performing, based on M transaction attribute values corresponding to the (k+1)^{th} transaction attribute type, (k+1)^{th} position sorting on the M candidate transaction data packets obtained after k^{th} position sorting; or
stop traversal of the N transaction attribute types in response to the M transaction attribute values corresponding to the k^{th} transaction attribute type not comprising transaction attribute values that are identical and are consecutive in position, and determining the M candidate transaction data packets obtained after k^{th} position sorting as the transaction data packet sequence.

15. The apparatus according to claim 13, wherein the N attribute value sets comprise an attribute value set Kₙ, and n is a positive integer less than or equal to N; and
wherein to respectively perform incremental encoding on the N attribute value sets, to obtain the N attribute value incremental encodings, the processor, upon execution of the plurality of instructions, is configured to:
respectively write the 1^{st} transaction attribute value in the attribute value set Kₙ into an incremental encoding set and a transaction attribute calibration field corresponding to the attribute value set Kₙ;
sequentially traverse the attribute value set Kₙ, to obtain an i^{th} transaction attribute value, i being a positive integer greater than or equal to 2 and less than or equal to M; and
sequentially add the i^{th} transaction attribute value to the incremental encoding set in response to the i^{th} transaction attribute value being different from a transaction attribute value comprised in the transaction attribute calibration field, and replace the transaction attribute value comprised in the transaction attribute calibration field with the i^{th} transaction attribute value; or
sequentially add a special encoding character to the incremental encoding set in response to the i^{th} transaction attribute value being identical to the transaction attribute value comprised in the transaction attribute calibration field until a determination that traversal of the attribute value set Kₙ is completed, and determine, based on the incremental encoding set, an attribute value incremental encoding corresponding to the attribute value set Kₙ.

16. The apparatus according to claim 13, wherein the N transaction attribute types comprise a transaction attribute type Tⱼ, and j is a positive integer less than or equal to N; and
wherein the processor, upon execution of the plurality of instructions, is further configured to:
obtain a type sliding window corresponding to the transaction attribute type Tⱼ, the type sliding window comprising L historical transaction attribute values corresponding to the transaction attribute type Tⱼ;
determine, based on transaction attribute values of the transaction attribute type Tⱼ that are comprised in the M transaction data packets and the type sliding window, a latest attribute value distance standard deviation corresponding to the transaction attribute type Tⱼ; and
determine, based on latest attribute value distance standard deviations respectively corresponding to the N transaction attribute types, the type priorities respectively corresponding to the N transaction attribute types when the latest attribute value distance standard deviations respectively corresponding to the N transaction attribute types are obtained.

17. A non-transitory computer-readable storage medium storing a plurality of instructions executable by a processor, wherein when loaded and executed by the processor, the plurality of instructions are configured to cause the processor to:
obtain M transaction data packets, each of the transaction data packets comprising transaction attribute values respectively corresponding to N transaction attribute types, and M and N being both positive integers;
determine a position order of the M transaction data packets based on type priorities respectively corresponding to the N transaction attribute types and the transaction attribute values, to obtain a transaction data packet sequence;
respectively generate, for the N transaction attribute types, attribute value sets in the position order based on the transaction attribute values corresponding to a same transaction attribute type in the transaction data packet sequence, to obtain N attribute value sets;
respectively perform incremental encoding on the N attribute value sets, to obtain N attribute value incremental encodings; and
perform block encapsulation on the N attribute value incremental encodings, to obtain a pending block, the pending block being configured to be added to a blockchain when consensus is reached.

18. The non-transitory computer-readable storage medium according to claim 17, wherein for the processor to determine the position order of the M transaction data packets based on type priorities respectively corresponding to the N transaction attribute types and the transaction attribute values, to obtain the transaction data packet sequence, the plurality of instructions, when loaded and executed by the processor, are configured to cause the processor to:
traverse the N transaction attribute types based on the type priorities respectively corresponding to the N transaction attribute types, to obtain a k^{th} transaction attribute type, a type priority corresponding to the k^{th} transaction attribute type being lower than a type priority corresponding to an obtained (k−1)^{th} transaction attribute type;
perform, based on M transaction attribute values corresponding to the k^{th} transaction attribute type, k^{th} position sorting on M candidate transaction data packets obtained after (k−1)^{th} position sorting, to obtain M candidate transaction data packets after k^{th} position sorting, the M candidate transaction data packets obtained after (k−1)^{th} position sorting being the M transaction data packets when k is 1; and
further obtain a (k+1)^{th} transaction attribute type in response to the M transaction attribute values corresponding to the k^{th} transaction attribute type comprising identical transaction attribute values, and performing, based on M transaction attribute values corresponding to the (k+1)^{th} transaction attribute type, (k+1)^{th} position sorting on the M candidate transaction data packets obtained after k^{th} position sorting; or
stop traversal of the N transaction attribute types in response to the M transaction attribute values corresponding to the k^{th} transaction attribute type not comprising transaction attribute values that are identical and are consecutive in position, and determining the M candidate transaction data packets obtained after k^{th} position sorting as the transaction data packet sequence.

19. The non-transitory computer-readable storage medium according to claim 17, wherein the N attribute value sets comprise an attribute value set Kₙ, and n is a positive integer less than or equal to N; and
wherein for the processor to respectively perform incremental encoding on the N attribute value sets, to obtain the N attribute value incremental encodings, the plurality of instructions, when loaded and executed by processor, are configured to cause the processor to:
respectively write the 1^{st} transaction attribute value in the attribute value set Kₙ into an incremental encoding set and a transaction attribute calibration field corresponding to the attribute value set Kₙ;
sequentially traverse the attribute value set Kₙ, to obtain an i^{th} transaction attribute value, i being a positive integer greater than or equal to 2 and less than or equal to M; and
sequentially add the i^{th} transaction attribute value to the incremental encoding set in response to the i^{th} transaction attribute value being different from a transaction attribute value comprised in the transaction attribute calibration field, and replace the transaction attribute value comprised in the transaction attribute calibration field with the i^{th} transaction attribute value; or
sequentially add a special encoding character to the incremental encoding set in response to the i^{th} transaction attribute value being identical to the transaction attribute value comprised in the transaction attribute calibration field until a determination that traversal of the attribute value set Kₙ is completed, and determine, based on the incremental encoding set, an attribute value incremental encoding corresponding to the attribute value set Kₙ.

20. The non-transitory computer-readable storage medium according to claim 17, wherein the N transaction attribute types comprise a transaction attribute type Tⱼ, and j is a positive integer less than or equal to N; and
wherein the plurality of instructions, when loaded and executed by the processor, are further configured to cause the processor to:
obtain a type sliding window corresponding to the transaction attribute type Tⱼ, the type sliding window comprising L historical transaction attribute values corresponding to the transaction attribute type Tⱼ;
determine, based on transaction attribute values of the transaction attribute type Tⱼ that are comprised in the M transaction data packets and the type sliding window, a latest attribute value distance standard deviation corresponding to the transaction attribute type Tⱼ; and
determine, based on latest attribute value distance standard deviations respectively corresponding to the N transaction attribute types, the type priorities respectively corresponding to the N transaction attribute types when the latest attribute value distance standard deviations respectively corresponding to the N transaction attribute types are obtained.
